(19) United States
(12) Patent Application Publication
(10) Pub. No.: US 2026/0122519 A1
(43) Pub. Date: Apr. 30, 2026

(54) DYNAMIC SELECTION OF LOWER-LAYER RADIO LINK PARAMETERS

(71) Applicant: QUALCOMM Incorporated, San Diego, CA (US)

(72) Inventors: Doohyun SUNG, Basking Ridge, NJ (US); Junyi LI, Greentown, PA (US); Jelena DAMNJANOVIC, Del Mar, CA (US); Qiaoyu LI, Beijing (CN)

(21) Appl. No.: 18/926,238

(22) Filed: Oct. 24, 2024

(51) Int. Cl. H04W 24/10; H04L 1/1867; H04L 1/20

(52) U.S. Cl. CPC H04W 24/10; H04L 1/1896; H04L 1/203

(57) ABSTRACT

Various aspects of the present disclosure generally relate to wireless communication. Some aspects more specifically relate to configuration of downlink and/or uplink quality of service (QoS) based radio link monitoring and prediction and related signaling and procedures. In some aspects, a network node may configure a user equipment (UE) with set(s) of physical (PHY) and/or medium access control (MAC) parameters for QoS radio link monitoring and reporting. Once configured with the parameter sets, the UE may receive a signal from the network node to use a particular set, or may autonomously select a set using traffic requirements. The network node may schedule the UE to send a QoS report in accordance with one or more downlink or uplink measurement and/or prediction results. For example, when the monitored results exceed one or more configured threshold(s), the UE may transmit a report to the network node.

### FIELD OF THE DISCLOSURE

Aspects of the present disclosure generally relate to wireless communication and specifically relate to techniques, apparatuses, and methods associated with dynamic selection of lower-layer link parameters.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (cMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples.

“Quality of service” (QoS) refers to a measure of performance of a network service or application. Network services or applications may have different Qos requirements (for example, a video call may have higher QoS requirements than a voice call). A user equipment (UE) may perform radio link management (RLM), such as beam failure detection (BFD) or radio link failure (RLF) detection, without regard to QoS requirements, which may impede radio link quality and/or use excessive resources. For example, the UE may perform or skip BFD or RLF operations in a manner inconsistent with QoS requirements.

### SUMMARY

Some aspects described herein relate to an apparatus for wireless communication at a user equipment (UE). The apparatus may include one or more memories storing processor-executable code and one or more processors coupled with the one or more memories. At least one processor of the one or more processors may be configured to cause the UE to receive a radio link configuration of one or more sets of lower-layer radio link parameters. At least one processor of the one or more processors may be configured to cause the UE to transmit, in accordance with the radio link configuration, a channel status report associated with one or more dynamically selected sets of the one or more sets of lower-layer radio link parameters.

Some aspects described herein relate to an apparatus for wireless communication at a network node. The apparatus may include one or more memories storing processor-executable code and one or more processors coupled with the one or more memories. At least one processor of the one or more processors may be configured to cause the network node to transmit a radio link configuration of one or more sets of lower-layer radio link parameters. At least one processor of the one or more processors may be configured to cause the network node to receive, in accordance with the radio link configuration, a channel status report associated with one or more dynamically selected sets of the one or more sets of lower-layer radio link parameters.

Some aspects described herein relate to a method of wireless communication performed at a UE. The method may include receiving a radio link configuration of one or more sets of lower-layer radio link parameters. The method may include transmitting, in accordance with the radio link configuration, a channel status report associated with one or more dynamically selected sets of the one or more sets of lower-layer radio link parameters.

Some aspects described herein relate to a method of wireless communication performed at a network node. The method may include transmitting a radio link configuration of one or more sets of lower-layer radio link parameters. The method may include receiving, in accordance with the radio link configuration, a channel status report associated with one or more dynamically selected sets of the one or more sets of lower-layer radio link parameters.

Some aspects described herein relate to a non-transitory computer-readable medium storing a set of instructions for wireless communication. The set of instructions may include one or more instructions that, when executed at a UE, cause the UE to receive a radio link configuration of one or more sets of lower-layer radio link parameters. The set of instructions may include one or more instructions that, when executed at the UE, cause the UE to transmit, in accordance with the radio link configuration, a channel status report associated with one or more dynamically selected sets of the one or more sets of lower-layer radio link parameters.

Some aspects described herein relate to a non-transitory computer-readable medium storing a set of instructions for wireless communication. The set of instructions may include one or more instructions that, when executed at a network node, cause the network node to transmit a radio link configuration of one or more sets of lower-layer radio link parameters. The set of instructions may include one or more instructions that, when executed at the network node, cause the network node to receive, in accordance with the radio link configuration, a channel status report associated with one or more dynamically selected sets of the one or more sets of lower-layer radio link parameters.

Some aspects described herein relate to an apparatus for wireless communication. The apparatus may include means for receiving a radio link configuration of one or more sets of lower-layer radio link parameters. The apparatus may include means for transmitting, in accordance with the radio link configuration, a channel status report associated with one or more dynamically selected sets of the one or more sets of lower-layer radio link parameters.

Some aspects described herein relate to an apparatus for wireless communication. The apparatus may include means for transmitting a radio link configuration of one or more sets of lower-layer radio link parameters. The apparatus may include means for receiving, in accordance with the radio link configuration, a channel status report associated with one or more dynamically selected sets of the one or more sets of lower-layer radio link parameters.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example associated with signaling involving dynamic selection of lower-layer radio link parameters, in accordance with the present disclosure.

FIG. 3 is a diagram illustrating an example associated with dynamic selection of lower-layer radio link parameters for uplink transmissions, in accordance with the present disclosure.

FIG. 4 is a flowchart illustrating an example process performed, for example, at a user equipment (UE) or an apparatus of a UE that supports dynamic selection of lower-layer link parameters, in accordance with the present disclosure.

FIG. 5 is a flowchart illustrating an example process performed, for example, at a network node or an apparatus of a network node that supports dynamic selection of lower-layer link parameters, in accordance with the present disclosure.

FIG. 6 is a diagram of an example apparatus for wireless communication, such as a UE or an apparatus of a UE, that supports dynamic selection of lower-layer link parameters in accordance with the present disclosure.

FIG. 7 is a diagram of an example apparatus for wireless communication, such as a network node or an apparatus of a network node, that supports dynamic selection of lower-layer link parameters in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

Downlink user equipment (UE) radio link management (RLM) may involve beam failure detection (BFD) and radio link failure (RLF) detection operations that are agnostic to quality of service (QoS) (for example, the BFD and RLF detection operations may not take into account QoS). Moreover, uplink UE RLM may rely on RLF detection using radio link control (RLC) maximum retransmission, which may be available only for acknowledge mode (AM) radio bearers, and not for unacknowledged mode (UM) or transparent mode (TM) radio bearers. As a result, QoS-specific UE radio link quality reporting is not supported. Thus, for example, channel status reports that are independent of QoS may trigger unnecessary BFD or RLF operations that involve excessive processing and/or memory resources. Additionally or alternatively, such channel status reports may trigger skipping of BFD or RLF operations that would otherwise help to improve radio link quality in accordance with QoS requirements.

Various aspects relate generally to QoS-based radio link reporting. Some aspects more specifically relate to configuration of downlink and/or uplink QoS-based radio link monitoring and prediction and related signaling and procedures. In some aspects, a UE may indicate, to a network node, UE capabilities for QoS-based radio link reporting. The network node may, in accordance with the UE capabilities, configure set(s) of physical (PHY) and/or medium access control (MAC) parameters for QoS radio link monitoring and reporting. For example, the network node may configure multiple downlink and/or uplink PHY/MAC parameter sets via radio resource control (RRC) signaling. Once configured with the parameter sets, the UE may receive a signal from the network node to use a particular set, or may autonomously select a set using traffic requirements (for example, using a 5G QoS identifier (5QI)). The network node may schedule the UE to send a QoS report in accordance with one or more downlink or uplink measurement and/or prediction results. For example, when the monitored results exceed one or more configured threshold(s), the UE may transmit a report to the network node.

In some examples, the QoS report may indicate degradation in recent and/or future link quality, and the network node may trigger a countermeasure for downlink and/or uplink. For example, if the QoS report indicates that the uplink channel is experiencing (or is predicted to experience) radio link quality degradation and the downlink channel is not, then the network node may trigger identification of a new uplink carrier (for example, another uplink carrier associated with the current network or with another network node). Upon reporting the radio uplink quality issue, the UE may assist the network node by transmitting an uplink signal to other carriers or cells, which may enable the network node to identify an uplink that is auxiliary to a current uplink. The UE may transmit the uplink signal to a different carrier or different network node autonomously or in response to being triggered by the network node. For example, the network node may trigger a dedicated uplink signal transmission from the UE. For example, upon identifying a strong uplink candidate, the network node may inform the UE to send the uplink signal to the uplink candidate. In some examples, the network node may negotiate with neighboring network nodes to receive an indication of uplink signal measurement results. The network node may transmit, to the UE, signaling to switch to a new uplink carrier in accordance with the uplink signal measurement results, and the UE may transmit data and/or control traffic through the new uplink carrier.

Particular aspects of the subject matter described in this disclosure can be implemented to realize one or more of the following potential advantages. In some examples, the described techniques can be used to enable QoS-specific UE radio link quality reporting. For example, the QoS report may enable radio-bearer-specific radio link monitoring and/or prediction in the downlink and/or the uplink. For example, the PHY/MAC parameter sets may enable the UE to monitor and/or predict whether QoS requirements are met for different types of traffic (which may have different QoS requirements). As a result, the UE may avoid unnecessary BFD or RLF operations, thereby conserving processing and/or memory resources. Additionally or alternatively, the channel status report may help to trigger BFD or RLF operations that improve radio link quality in accordance with QoS requirements.

Switching to the new uplink carrier may help to resolve degraded radio link quality. For example, the new uplink carrier or neighboring cell may support improved radio uplink quality, thereby helping to improve uplink transmission success, reduce uplink retransmissions, and conserve processing and/or memory resources.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (cMBB) access, Internet of Things (IoT) networks or reduced capability (RedCap) device deployments, URLLC applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

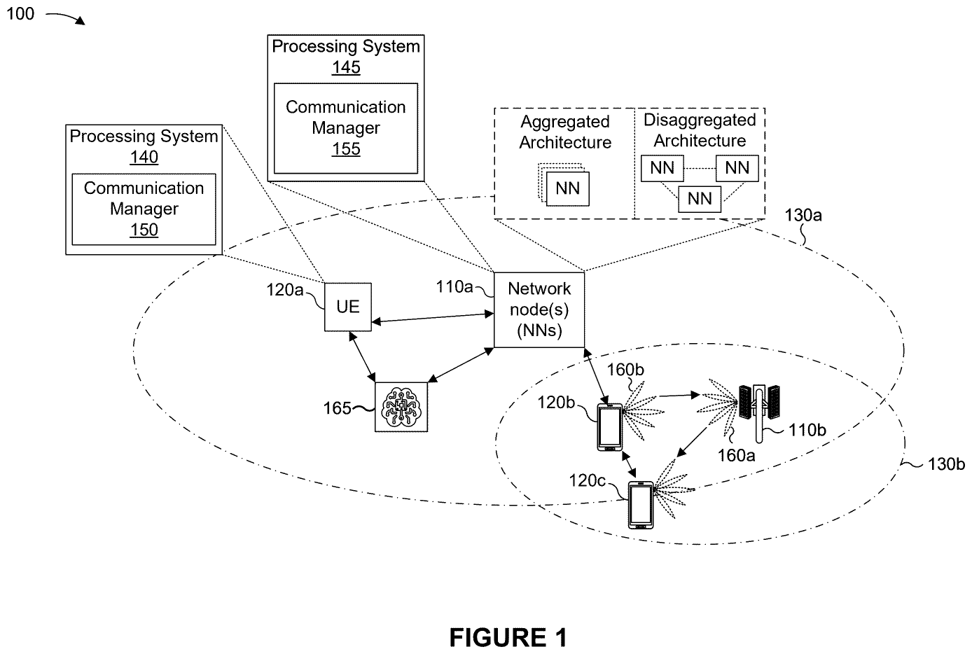

FIG. 1 is a diagram illustrating an example of a wireless communication network 100 in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a and a network node 110b. The network nodes 110 may support communications with multiple UEs 120. For example, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHZ through 114.25 GHZ), and FR5 (114.25 GHz through 300 GHZ). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

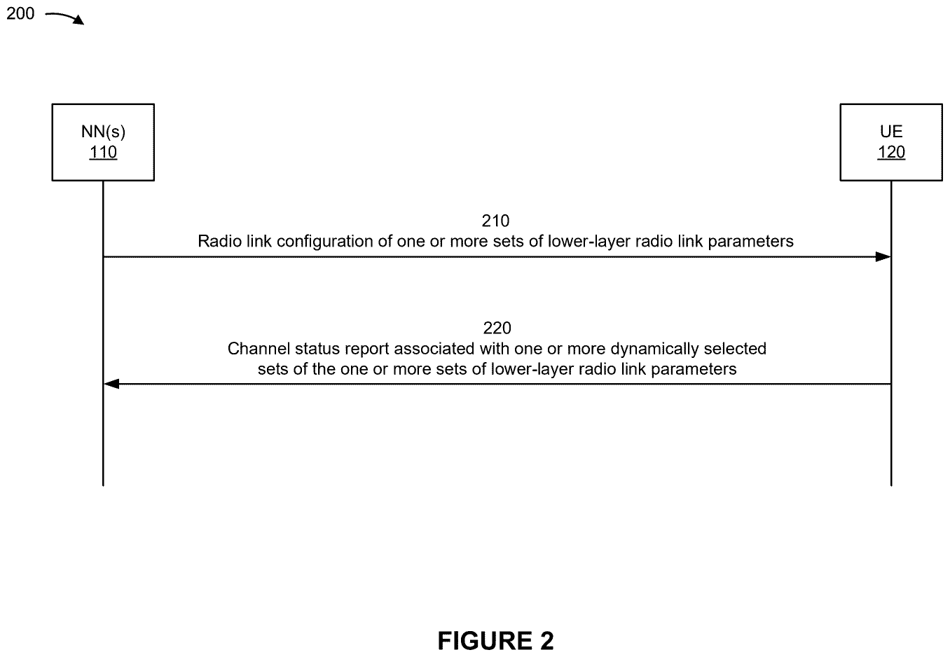

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a RRC layer, a packet data convergence protocol (PDCP) layer, and a service data adaptation protocol (SDAP) layer, among other examples. A DU may host one or more of a RLC layer, a MAC layer, and/or one or more higher PHY layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some aspects, the UE 120 may include a communication manager 150. As described in more detail elsewhere herein, the communication manager 150 may receive a radio link configuration of one or more sets of lower-layer radio link parameters; and transmit, in accordance with the radio link configuration, a channel status report associated with one or more dynamically selected sets of the one or more sets of lower-layer radio link parameters. Additionally or alternatively, the communication manager 150 may perform one or more other operations described herein.

In some aspects, the network node 110 may include a communication manager 155. As described in more detail elsewhere herein, the communication manager 155 may transmit a radio link configuration of one or more sets of lower-layer radio link parameters; and receive, in accordance with the radio link configuration, a channel status report associated with one or more dynamically selected sets of the one or more sets of lower-layer radio link parameters. Additionally or alternatively, the communication manager 155 may perform one or more other operations described herein.

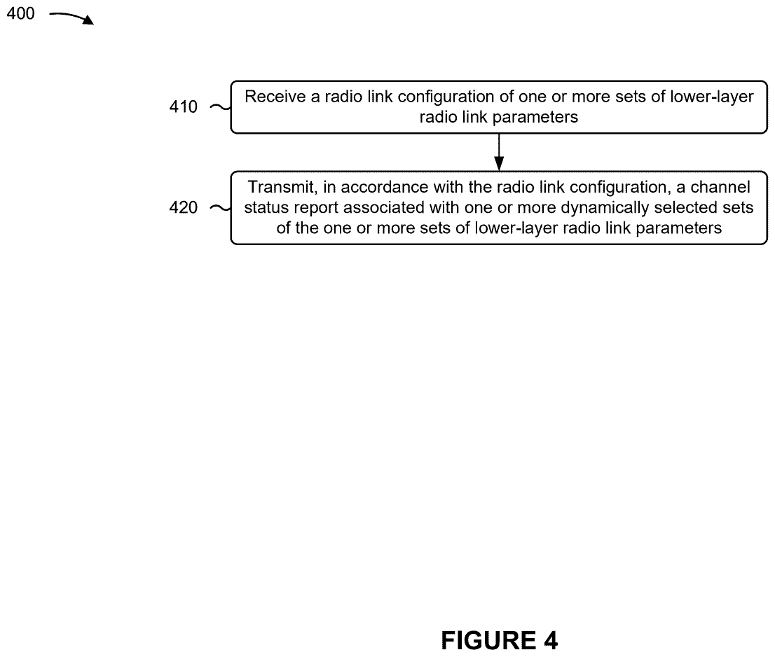

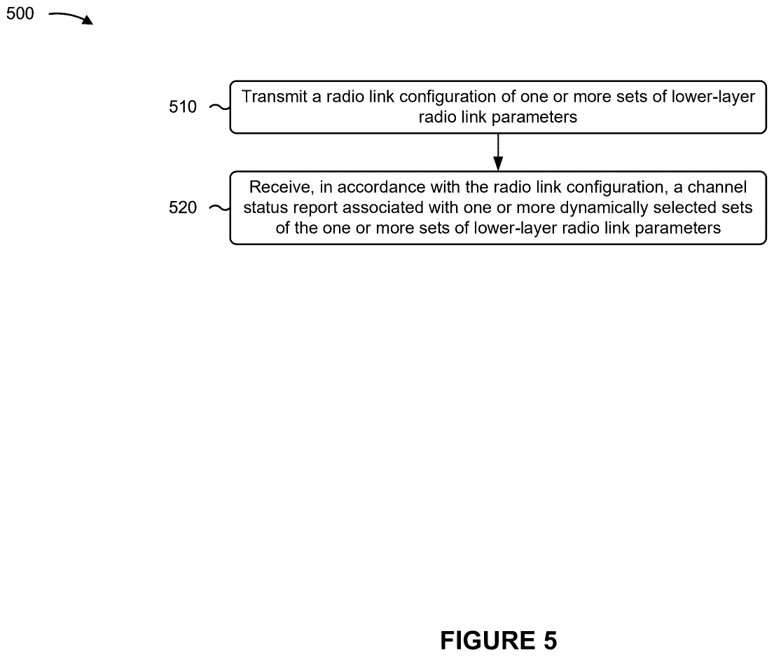

The network node 110, the processing system 145 of the network node 110, the UE 120, the processing system 140 of the UE 120, or any other component(s) of FIG. 1 may implement one or more techniques or perform one or more operations associated with dynamic selection of lower-layer link parameters, as described in more detail elsewhere herein. For example, the processing system 145 of the network node 110 or the processing system 140 of the UE 120 may perform or direct operations of, for example, process 400 of FIG. 4, process 500 of FIG. 5, or other processes as described herein (alone or in conjunction with one or more other processors). Memory of the network node 110 may store data and program code (or instructions) for the network node 110. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110 and/or the UE 120 may cause the one or more processors to perform process 400 of FIG. 4, process 500 of FIG. 5, or other processes as described herein. In some examples, executing instructions may include running the instructions, converting the instructions, compiling the instructions, and/or interpreting the instructions, among other examples.

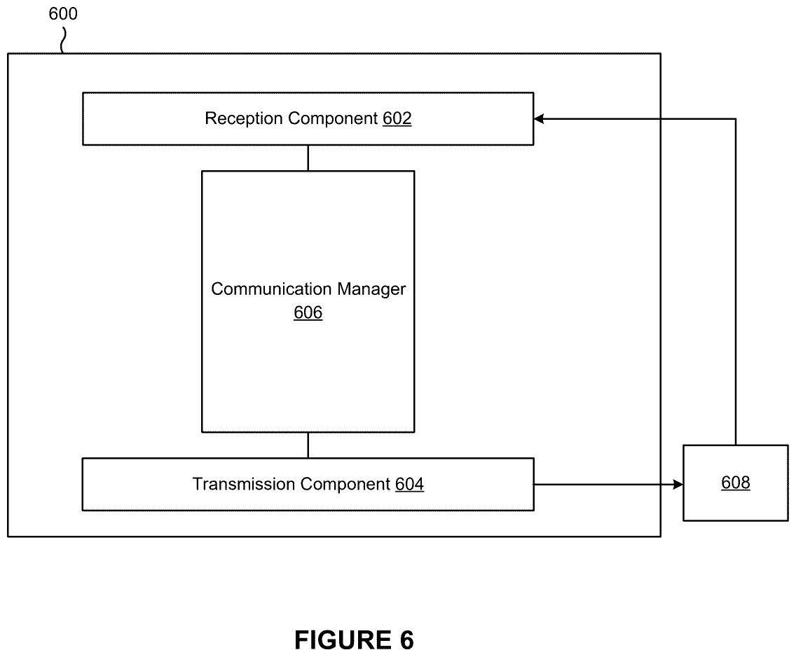

In some aspects, the UE 120 includes means for receiving a radio link configuration of one or more sets of lower-layer radio link parameters; and/or means for transmitting, in accordance with the radio link configuration, a channel status report associated with one or more dynamically selected sets of the one or more sets of lower-layer radio link parameters. The means for the UE 120 to perform operations described herein may include, for example, one or more of communication manager 150, processing system 140, a radio, one or more RF chains, one or more transceivers, one or more antennas, one or more modems, a reception component (for example, reception component 602 depicted and described in connection with FIG. 6), and/or a transmission component (for example, transmission component 604 depicted and described in connection with FIG. 6), among other examples.

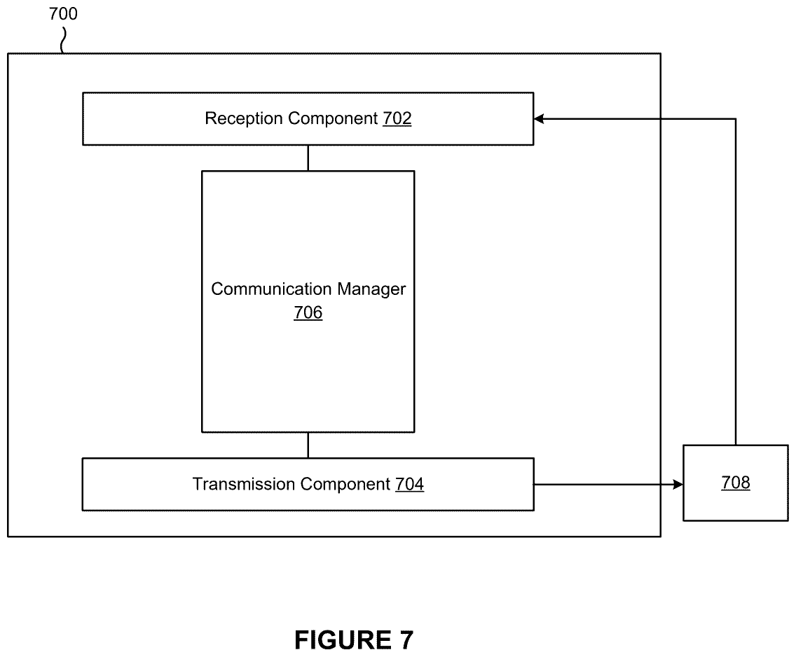

In some aspects, the network node includes means for transmitting a radio link configuration of one or more sets of lower-layer radio link parameters; and/or means for receiving, in accordance with the radio link configuration, a channel status report associated with one or more dynamically selected sets of the one or more sets of lower-layer radio link parameters. The means for the network node to perform operations described herein may include, for example, one or more of communication manager 155, processing system 145, a radio, one or more RF chains, one or more transceivers, one or more antennas, one or more modems, a reception component (for example, reception component 702 depicted and described in connection with FIG. 7), and/or a transmission component (for example, transmission component 704 depicted and described in connection with FIG. 7), among other examples.

In some examples, AI/ML may be used to enhance aspects of the air interface between the network node 110 and the UE 120 (for example, beam management, positioning accuracy, or CSI feedback, among other examples) or mobility performance (for example, radio resource management (RRM) measurement and event prediction, such as handover (HO) failure, radio link failure (RLF), or measurement events, among other examples). AI/ML-based measurement and event prediction may improve overall RAN performance by reducing reference signal transmission (and thereby increasing a quantity of resources that are available for data) and/or increasing the service continuity (and thereby proactively reducing service disruption due to RLF or HO).

In some examples, the UE 120 may perform radio link monitoring using BFD and/or RLF operations. For example, the UE 120 may use one or more PDCCH transmission parameters to perform a BFD evaluation. For example, on each reference signal resource configuration in a set, the UE 120 may estimate a radio link quality and compare the radio link quality to a threshold Q_{out_LR}, which may enable the UE 120 to access downlink radio link quality of serving cell beams. The threshold Q_{out_LR} may be a level at which a downlink radio level link of a given resource configuration on the set cannot be reliably received, and may correspond to the BLERₒᵤₜ=10% block error rate (BLER) of a hypothetical PDCCH transmission. For SSB-based BFD, the threshold Q_{out_LR} may be referred to as Q_{out_LR} SSB, and may be derived using the hypothetical PDCCH transmission parameters listed below in Table 1. For CSI-RS-based BFD, the threshold Q_{out_LR} may be referred to as Q_{out_LR_CSI-RS}, and may be derived using the hypothetical PDCCH transmission parameters listed below in Table 2.

TABLE 1

| Attribute | Value for BLER |
|---|---|
| DCI format | 1-0 |
| Quantity of control OFDM symbols | 2 |
| Aggregation level (control channel | 8 |
| element (CCE)) | |
| Ratio of hypothetical PDCCH resource | 0 dB |
| element (RE) energy to average SSS RE | |
| energy | |
| Ratio of hypothetical PDCCH DMRS | 0 dB |
| energy to average SSS RE energy | |
| Bandwidth (physical resource blocks | 24 |
| (PRBs)) | |
| Sub-carrier spacing (kHz) | Same as the SCS |
| | of remaining |
| | minimum system |
| | information (RMSI) |
| | control resource |
| | set (CORESET) |
| DMRS precoder granularity | RE group (REG) |
| | bundle size |
| REG bundle size | 6 |
| Cyclic prefix (CP) length | Normal |
| Mapping from REG to CCE | Distributed |

TABLE 2

| Attribute | Value for BLER |
|---|---|
| DCI format | 1-0 |
| Number of control OFDM symbols | 2 |
| Aggregation level (CCE) | 8 |
| Ratio of hypothetical PDCCH RE energy to | 0 dB |
| average CSI-RS RE energy | |
| Ratio of hypothetical PDCCH DMRS | 0 dB |
| energy to average CSI-RS RE energy | |
| Bandwidth (PRBs) | 48 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

The UE 120 may evaluate whether the radio link quality satisfies the threshold Q_{out_LR} in a BFD evaluation period. For SSB-based BFD, values for the BFD evaluation period for FR1 are provided below in Table 3, and values for the BFD evaluation period for FR2 are provided below in Table 4. For CSI-RS-based BFD, values for the BFD evaluation period for FR1 are provided below in Table 5, and values for the BFD evaluation period for FR2 are provided below in Table 6. T_{SSB} is a periodicity of an SSB in the set, T_{CSI-RS} is a periodicity of a CSI-RS resource in the set, T_{DRX} is a DRX cycle length, P is associated with antenna capabilities of the UE 120, N is a quantity of discontinuous reception (DRX) cycles, M_{BFD} is associated with a density and/or bandwidth configuration on the set, and P_{BFD} is associated with a cell configuration on the set (for example, a primary cell, secondary cell, or primary and secondary cell configuration).

TABLE 3

| Configuration | BFD evaluation period (ms) |
|---|---|
| No DRX | Max(50, Ceil(5 × P) × T_{SSB}) |
| DRX cycle ≤ 320 ms | Max(50, Ceil(7.5 × P) × Max(T_{DRX}, T_{SSB})) |
| DRX cycle > 320 ms | Ceil(5 × P) × T_{DRX} |

TABLE 4

| Configuration | BFD evaluation period (ms) |
|---|---|
| No DRX | Max(50, Ceil(5 × P × N) × T_{SSB}) |
| DRX cycle ≤ 320 ms | Max(50, Ceil(7.5 × P × N) × Max(T_{DRX}, T_{SSB})) |
| DRX cycle > 320 ms | Ceil(5 × P × N) × T_{DRX} |

TABLE 5

| Configuration | BFD evaluation period (ms) |
|---|---|
| No DRX | Max(50, Ceil(M_{BFD} × P × P_{BFD}) × T_{CSI-RS}) |
| DRX cycle ≤ 320 ms | Max(50, Ceil(1.5 × M_{BFD} × P × P_{BFD}) × |
| | Max(T_{DRX}, T_{CSI-RS})) |
| DRX cycle > 320 ms | Ceil(M_{BFD} × P × P_{BFD}) × T_{DRX} |

TABLE 6

| Configuration | BFD evaluation period (ms) |
|---|---|
| no DRX | Max(50, Ceil(M_{BFD} × P × N × P_{BFD}) × T_{CSI-RS}) |
| DRX cycle ≤ 320 ms | Max(50, Ceil(1.5 × M_{BFD} × P × N × P_{BFD}) × |
| | Max(T_{DRX}, T_{CSI-RS})) |
| DRX cycle > 320 ms | Ceil(M_{BFD} × P × N × P_{BFD}) × T_{DRX} |

In some examples, the UE 120 may use one or more PDCCH transmission parameters to perform an RLM evaluation. For example, on each RLM reference signal resource, the UE 120 may estimate a downlink radio link quality and compare the downlink radio link quality to thresholds Qₒᵤₜ and Qᵢₙ, which may enable the UE 120 to monitor the downlink radio link quality of a cell. The threshold Qₒᵤₜ may be a level at which the downlink radio link cannot be reliably received, and the threshold Qᵢₙ may be a level at which the downlink radio link quality can be received with significantly higher reliability than at Qₒᵤₜ. The threshold Qₒᵤₜ may correspond to an out-of-sync block error rate (BLERₒᵤₜ), and the threshold Qᵢₙ may correspond to an in-sync block error rate (BLERᵢₙ), as shown below in Table 7. For SSB-based RLM, the threshold Qₒᵤₜ may be referred to as Q_{out_SSB}, and may be derived using the hypothetical PDCCH transmission parameters listed below in Table 8. For SSB-based RLM, the threshold Qᵢₙ may be referred to as Q_{in_SSB}, and may be derived using the hypothetical PDCCH transmission parameters listed below in Table 9. For CSI-RS-based RLM, the threshold Qₒᵤₜ may be referred to as Q_{out_CSI-RS}, and may be derived using the hypothetical PDCCH transmission parameters listed below in Table 10. For CSI-RS-based RLM, the threshold Qᵢₙ may be referred to as Q_{in_CSI-RS}, and may be derived using the hypothetical PDCCH transmission parameters listed below in Table 11.

TABLE 7

| Configuration | BLERₒᵤₜ | BLERᵢₙ |
|---|---|---|
| 0 | 10% | 2% |

TABLE 8

| | Value for BLER |
|---|---|
| Attribute | configuration #0 |
| DCI format | 1-0 |
| Number of control OFDM symbols | 2 |
| Aggregation level (CCE) | 8 |
| Ratio of hypothetical PDCCH RE | 4 dB |
| energy to average SSS RE energy | |
| Ratio of hypothetical PDCCH DMRS | 4 dB |
| energy to average SSS RE energy | |
| Bandwidth (PRBs) | 24 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

TABLE 9

| | Value for BLER |
|---|---|
| Attribute | Configuration #0 |
| DCI payload size | 1-0 |
| Number of control OFDM symbols | 2 |
| Aggregation level (CCE) | 4 |
| Ratio of hypothetical PDCCH RE | 0 dB |
| energy to average SSS RE energy | |
| Ratio of hypothetical PDCCH DMRS | 0 dB |
| energy to average SSS RE energy | |
| Bandwidth (PRBs) | 24 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

TABLE 10

| | Value for BLER |
|---|---|
| Attribute | Configuration #0 |
| DCI format | 1-0 |
| Number of control OFDM symbols | 2 |
| Aggregation level (CCE) | 8 |
| Ratio of hypothetical PDCCH RE | 4 dB |
| energy to average CSI-RS RE energy | |
| Ratio of hypothetical PDCCH DMRS | 4 dB |
| energy to average CSI-RS RE energy | |
| Bandwidth (PRBs) | 48 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

TABLE 11

| | Value for BLER |
|---|---|
| Attribute | Configuration #0 |
| DCI payload size | 1-0 |
| Number of control OFDM symbols | 2 |
| Aggregation level (CCE) | 4 |
| Ratio of hypothetical PDCCH RE | 0 dB |
| energy to average CSI-RS RE energy | |
| Ratio of hypothetical PDCCH DMRS | 0 dB |
| energy to average CSI-RS RE energy | |
| Bandwidth (PRBs) | 48 |
| Sub-carrier spacing (kHz) | SCS of the active DL BWP |
| DMRS precoder granularity | REG bundle size |
| REG bundle size | 6 |
| CP length | Normal |
| Mapping from REG to CCE | Distributed |

The UE 120 may evaluate whether the radio link quality satisfies the thresholds Qₒᵤₜ and Qᵢₙ in respective RLM evaluation periods T_{Evaluate_out} and T_{Evaluate_in}. For SSB-based RLM, T_{Evaluate_out} may be referred to as T_{Evaluate_out _SSB}, and T_{Evaluate_in} may be referred to as T_{Evaluate_in_SSB}. For SSB-based RLM, T_{Evaluate_out} may be referred to as T_{Evaluate_out_CSI-RS}, and T_{Evaluate_in} may be referred to as T_{Evaluate_in_CSI-RS}. Values for T_{Evaluate_out_SSB} and T_{Evaluate_in_SSB} for FR1 are provided below in Table 12, and values for T_{Evaluate_out_SSB} and T_{Evaluate_in_SSB} for FR2 are provided below in Table 13. Values for T_{Evaluate_out_CSI-RS} and T_{Evaluate_in_CSI-RS} for FR1 are provided below in Table 14, and values for T_{Evaluate_out_CSI-RS} and T_{Evaluate_in_CSI-RS} for FR2 are provided below in Table 15. Mₒᵤₜ corresponds to the threshold Qₒᵤₜ and is associated with a density and/or bandwidth configuration, and Min corresponds to the threshold Qᵢₙ and is associated with a density and/or bandwidth configuration on the set.

TABLE 12

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | Max(200, Ceil(10 × P) × T_{SSB}) | Max(100, Ceil(5 × P) × T_{SSB}) |
| DRX cycle ≤ 320 ms | Max(200, Ceil(15 × P) × | Max(100, Ceil(7.5 × P) × |
| | Max(T_{DRX}, T_{SSB})) | Max(T_{DRX}, T_{SSB})) |
| DRX cycle > 320 ms | Ceil(10 × P) × T_{DRX} | Ceil(5 × P) × T_{DRX} |

TABLE 13

| Configuration | T_{Evaluate}_{_{—}}ₒᵤₜ_{_{—}}_{SSB} (ms) | T_{Evaluate}_{_{—}}ᵢₙ_{_{—}}_{SSB} (ms) |
|---|---|---|
| no DRX | Max(200, Ceil(10 × P × N) × | Max(100, Ceil(5 × P × N) × |
| | T_{SSB}) | T_{SSB}) |
| DRX cycle ≤ 320 ms | Max(200, Ceil(15 × P × N) × | Max(100, Ceil(7.5 × P × N) × |
| | Max(T_{DRX}, T_{SSB})) | Max(T_{DRX}, T_{SSB})) |
| DRX cycle > 320 ms | Ceil(10 × P × N) × T_{DRX} | Ceil(5 × P × N) × T_{DRX} |

TABLE 14

| Configuration | T_{Evaluate}_{_{—}}ₒᵤₜ_{_{—}}_{CSI-RS} (ms) | T_{Evaluate}_{_{—}}ᵢₙ_{_{—}}_{CSI-RS} (ms) |
|---|---|---|
| no DRX | Max(200, Ceil(Mₒᵤₜ × P) × T_{CSI-RS}) | Max(100, Ceil(Mᵢₙ × P) × T_{CSI-RS}) |
| DRX ≤ 320 ms | Max(200, Ceil(1.5 × Mₒᵤₜ × P) × | Max(100, Ceil(1.5 × Mᵢₙ × P) × |
| | Max(T_{DRX}, T_{CSI-RS})) | Max(T_{DRX}, T_{CSI-RS})) |
| DRX > 320 ms | Ceil(Mₒᵤₜ × P) × T_{DRX} | Ceil(Mᵢₙ × P) × T_{DRX} |

TABLE 15

| Configuration | T_{Evaluate}_{_{—}}ₒᵤₜ_{_{—}}_{CSI-RS} (ms) | T_{Evaluate}_{_{—}}ᵢₙ_{_{—}}_{CSI-RS} (ms) |
|---|---|---|
| no DRX | Max(200, Ceil(Mₒᵤₜ × P × N) × | Max(100, Ceil(Mᵢₙ × P × N) × |
| | T_{CSI-RS}) | T_{CSI-RS}) |
| DRX ≤ 320 ms | Max(200, Ceil(1.5 × Mₒᵤₜ × P × N) × | Max(100, Ceil(1.5 × Mᵢₙ × P × N) × |
| | Max(T_{DRX}, T_{CSI-RS})) | Max(T_{DRX}, T_{CSI-RS})) |
| DRX > 320 ms | Ceil(Mₒᵤₜ × P × N) × T_{DRX} | Ceil(Mᵢₙ × P × N) × T_{DRX} |

RAN-level QoS can be provided for target applications, such as URLLC or XR, among other examples. 5QI is a scalar that maps to QoS characteristics, such as packet loss rate or packet delay budget, among other examples. A network may use the 5QI to identify QoS forwarding behavior, such as scheduling weights, admission thresholds, queue management thresholds, or link layer protocol configuration, among other examples. Table 16 below illustrates an example mapping between a 5QI value and QoS characteristics.

TABLE 16

| | | Default | Packet | Packet | Default | |
|---|---|---|---|---|---|---|
| 5QI | Resource | Priority | Delay | Error | Averaging | Example |
| Value | Type | Level | Budget | Rate | Window | Services |
| 1 | Guaranteed | 20 | 100 ms | 10⁻² | 2000 ms | Conversational |
| | bit rate | | | | | voice |

Downlink UE RLM may involve BFD and RLF operations, which can be defined as part of a BWP configuration. However, such BFD and RLF operations are agnostic to QoS (for example, the BFD and RLF operations do not depend on QoS). Moreover, uplink UE RLM may rely on RLF detection using RLC maximum retransmission, which may be available for only AM radio bearers, and not for UM or TM radio bearers. As a result, QoS-specific UE radio link quality reporting is not supported, which can hinder radio link quality. Thus, channel status reports that are independent of QoS may trigger unnecessary BFD or RLF operations that involve excessive processing and/or memory resources. Additionally or alternatively, such channel status reports may trigger skipping of BFD or RLF operations that would otherwise help to improve radio link quality in accordance with QoS requirements.

FIG. 2 is a diagram illustrating an example 200 associated with signaling involving dynamic selection of lower-layer radio link parameters, in accordance with the present disclosure. As shown in FIG. 2, a network node 110 and a UE 120 may communicate with one another.

In a first operation 210, the network node 110 may transmit, and the UE 120 may receive, a radio link configuration of one or more sets of lower-layer radio link parameters. In some examples, the lower-layer radio link parameters may be layer 1 (L1) radio link parameters, such as PHY radio link parameters, or layer 2 (L2) radio link parameters, such as MAC radio link parameters. The radio link configuration may be a radio link monitoring configuration (for example, a radio link measurement configuration) and/or a radio link prediction configuration that configures the UE 120 with the one or more sets of lower-layer radio link parameters for radio link monitoring and/or radio link prediction (for example, AI/ML-based radio link prediction). For example, the radio link configuration may configure the UE 120 to use the one or more sets of lower-layer radio link parameters for QoS-specific downlink and/or uplink radio link quality monitoring and/or prediction. In some examples, the radio link configuration may be an RRC configuration.

In some aspects, the one or more sets of lower-layer radio link parameters may be BWP-specific, cell-specific, or carrier-specific. For example, each set of the lower-layer radio link parameters may be defined on a per-BWP basis, a per-cell basis, and/or a per-carrier basis.

In some aspects, the one or more sets of lower-layer radio link parameters may include one or more downlink lower-layer radio link parameters. The one or more downlink lower-layer radio link parameters may indicate a channel status of a downlink between the network node 110 and the UE 120.

For example, the one or more downlink lower-layer radio link parameters may include a prediction time window. The prediction time window may be a maximum length of time in which the UE 120 is to perform a radio link prediction. In some examples, the prediction time window may be referred to as a prediction duration.

Additionally or alternatively, the one or more downlink lower-layer radio link parameters may include one or more PDCCH parameters associated with one or more hypothetical PDCCH BLERs. The one or more PDCCH parameters may be associated with one or more hypothetical PDCCH BLERs in that the one or more PDCCH parameters may be used to identify the one or more hypothetical PDCCH BLERs. In some examples, the one or more sets of lower-layer radio link parameters may include one or more PDCCH parameter sets for hypothetical PDCCH BLERs. For example, the one or more PDCCH parameter sets may be defined in a wireless communication standard and identified using an identifier. In some examples, the one or more PDCCH parameter sets may be mapped to respective 5QI types.

Additionally or alternatively, the one or more downlink lower-layer radio link parameters may include one or more reference signal parameters associated with the one or more hypothetical PDCCH BLERs. The one or more reference signal parameters may be associated with the one or more hypothetical PDCCH BLERs in that the one or more reference signal parameters may be used to identify the one or more hypothetical PDCCH BLERs. For example, the one or more reference signal parameters may indicate one or more reference signals for hypothetical PDCCH BLER measurement.

Additionally or alternatively, the one or more downlink lower-layer radio link parameters may include an evaluation time window. The evaluation time window may be a length of time for which the UE 120 is to evaluate the downlink radio link quality. In some examples, the evaluation time window may be referred to as an “evaluation period.” The evaluation time window may be defined in a wireless communication standard and identified using an identifier.

Additionally or alternatively, the one or more downlink lower-layer radio link parameters may include one or more radio network temporary identifiers (RNTIs) associated with one or more HARQ BLERs. For example, the one or more downlink lower-layer radio link parameters may include a list of the RNTIs. The one or more RNTIs may be associated with the one or more HARQ BLERs in that the one or more HARQ BLERs may be measured for the one or more RNTIs. Thus, for example, the one or more RNTIs may correspond to respective QoS requirements. In some examples, the UE 120 may evaluate PDCCH communications and/or PDSCH communications scheduled with the one or more RNTIs during a time window (for example, the prediction time window).

Additionally or alternatively, the one or more downlink lower-layer radio link parameters may include radio bearer identifiers or logical channel identifiers associated with one or more RLC BLERs. For example, the one or more downlink lower-layer radio link parameters may include a list of the one or more radio bearer identifiers or logical channel identifiers. The one or more radio bearer identifiers or logical channel identifiers may be associated with the one or more RLC BLERs in that the one or more RLC BLERs may be measured for the one or more radio bearer identifiers or logical channel identifiers.

In some aspects, the radio link configuration may indicate one or more downlink lower-layer radio link parameter thresholds associated with the one or more downlink lower-layer radio link parameters. The one or more downlink lower-layer radio link parameter thresholds may be associated with the one or more downlink lower-layer radio link parameters in that the UE 120 may identify a radio downlink quality using the one or more downlink lower-layer radio link parameter thresholds and the one or more downlink lower-layer radio link parameters. For example, the UE 120 may identify a radio downlink quality in accordance with the one or more downlink lower-layer radio link parameters satisfying, or not satisfying, the one or more downlink lower-layer radio link parameter thresholds (for example, one or more values). For example, the one or more downlink lower-layer radio link parameter thresholds may be measurement thresholds, and the radio downlink quality may be a prediction result. If a downlink lower-layer radio link parameter is configured and a corresponding downlink lower-layer radio link parameter threshold is not configured, then the UE 120 may use a default value for the downlink lower-layer radio link parameter threshold (for example, a value that is defined in a wireless communication standard).

For example, the one or more downlink lower-layer radio link parameter thresholds may include a hypothetical PDCCH BLER threshold. For example, the UE 120 may identify whether a quantity of hypothetical PDCCH BLERs, calculated using the one or more downlink lower-layer radio link parameters, satisfies the hypothetical PDCCH BLER threshold.

Additionally or alternatively, the one or more downlink lower-layer radio link parameter thresholds may include a counter threshold associated with the PDCCH BLER threshold. The counter threshold may be associated with the PDCCH BLER threshold in that the counter threshold (for example, a maximum counter value) may correspond to a count of instances in which the quantity of hypothetical PDCCH BLERS satisfies the hypothetical PDCCH BLER threshold. For example, the UE 120 may identify whether the count of instances satisfies the counter threshold.

Additionally or alternatively, the one or more downlink lower-layer radio link parameter thresholds may include a HARQ BLER threshold. For example, the UE 120 may identify whether a quantity of HARQ BLERs, calculated using the one or more downlink lower-layer radio link parameters, satisfies the HARQ BLER threshold.

Additionally or alternatively, the one or more downlink lower-layer radio link parameter thresholds may include an RLC BLER threshold. For example, the UE 120 may identify whether a quantity of RLC BLERs, calculated using the one or more downlink lower-layer radio link parameters, satisfies the RLC BLER threshold.

In some aspects, the one or more sets of lower-layer radio link parameters may include one or more uplink lower-layer radio link parameters. The one or more uplink lower-layer radio link parameters may indicate a channel status of an uplink between the network node 110 and the UE 120.

For example, the one or more uplink lower-layer radio link parameters may include a prediction time window. The prediction time window may be a maximum length of time in which the UE 120 is to perform a radio link prediction. In some examples, the prediction time window may be referred to as a prediction duration.

Additionally or alternatively, the one or more uplink lower-layer radio link parameters may include a maximum permissible exposure (MPE). The MPE may be a maximum amount of permissible radiation exposure within a given time period, as mandated by a telecommunication standards organization and/or a communications regulatory agency.

Additionally or alternatively, the one or more uplink lower-layer radio link parameters may include a maximum power reduction (MPR). The MPR may indicate a minimum transmit power for low-priority cells.

Additionally or alternatively, the one or more uplink lower-layer radio link parameters may include one or more RNTIs associated with one or more HARQ BLERs. For example, the one or more uplink lower-layer radio link parameters may include a list of the RNTIs. The one or more RNTIs may be associated with the one or more HARQ BLERs in that the one or more HARQ BLERs may be measured for the one or more RNTIs. Thus, for example, the one or more RNTIs may correspond to respective QoS requirements. In some examples, the UE 120 may evaluate PUSCH communications scheduled with the one or more RNTIs during a time window (for example, the prediction time window).

Additionally or alternatively, the one or more uplink lower-layer radio link parameters may include one or more radio bearer identifiers or logical channel identifiers associated with one or more RLC BLERs. For example, the one or more uplink lower-layer radio link parameters may include a list of the one or more radio bearer identifiers or logical channel identifiers. The one or more radio bearer identifiers or logical channel identifiers may be associated with the one or more RLC BLERs in that the one or more RLC BLERs may be measured for the one or more radio bearer identifiers or logical channel identifiers.

Additionally or alternatively, the one or more uplink lower-layer radio link parameters may include or more radio bearer identifiers or logical channel identifiers associated with uplink transmission delay. For example, the one or more downlink lower-layer radio link parameters may include a list of the one or more radio bearer identifiers or logical channel identifiers. The one or more radio bearer identifiers or logical channel identifiers may be associated with the uplink transmission delay in that the uplink transmission delay may be measured for the one or more radio bearer identifiers or logical channel identifiers. For example, if the UE 120 is transmitting over only high-priority channels, then low-priority channels may experience large uplink transmission delays.

In some aspects, the radio link configuration may indicate one or more uplink lower-layer radio link parameter thresholds associated with the one or more uplink lower-layer radio link parameters. The one or more uplink lower-layer radio link parameter thresholds may be associated with the one or more uplink lower-layer radio link parameters in that UE 120 may identify a radio uplink quality using the one or more uplink lower-layer radio link parameter thresholds and the one or more uplink lower-layer radio link parameters. For example, the UE 120 may identify a radio uplink quality in accordance with the one or more uplink lower-layer radio link parameters satisfying, or not satisfying, the one or more uplink lower-layer radio link parameter thresholds (for example, one or more values). For example, the one or more uplink lower-layer radio link parameter thresholds may be measurement thresholds, and the radio uplink quality may be a prediction result. If an uplink lower-layer radio link parameter is configured and a corresponding uplink lower-layer radio link parameter threshold is not configured, then the UE 120 may use a default value for the uplink lower-layer radio link parameter threshold (for example, a value that is defined in a wireless communication standard).

For example, the one or more uplink lower-layer radio link parameter thresholds may include a HARQ BLER threshold. For example, the UE 120 may identify whether a quantity of HARQ BLERs, calculated using the one or more uplink lower-layer radio link parameters, satisfies the HARQ BLER threshold.

Additionally or alternatively, the one or more uplink lower-layer radio link parameter thresholds may include an RLC BLER threshold. For example, the UE 120 may identify whether a quantity of RLC BLERs, calculated using the one or more uplink lower-layer radio link parameters, satisfies the RLC BLER threshold.

Additionally or alternatively, the one or more uplink lower-layer radio link parameter thresholds may include an MPE threshold. For example, the UE 120 may identify whether an MPE, calculated using the one or more uplink lower-layer radio link parameters, satisfies the MPE threshold.

Additionally or alternatively, the one or more uplink lower-layer radio link parameter thresholds may include an MPR threshold. For example, the UE 120 may identify whether an MPR, calculated using the one or more uplink lower-layer radio link parameters, satisfies the MPR threshold.

Additionally or alternatively, the one or more uplink lower-layer radio link parameter thresholds may include an uplink transmission delay threshold. For example, the UE 120 may identify whether an uplink transmission delay, calculated using the one or more uplink lower-layer radio link parameters, satisfies the uplink transmission delay threshold.

Additionally or alternatively, the one or more uplink lower-layer radio link parameter thresholds may include an RLC retransmission threshold. For example, the UE 120 may identify whether a quantity of RLC retransmissions, calculated using the one or more uplink lower-layer radio link parameters, satisfies the RLC retransmission threshold. For example, the RLC retransmission threshold may be a maximum RLC retransmission threshold. In some examples, the UE 120 may apply the RLC retransmission threshold to an AM radio bearer.

In some aspects, the network node 110 may transmit, and the UE 120 may receive, an indication of one or more dynamically selected sets of the one or more sets of lower-layer radio link parameters. For example, the indication may dynamically select the one or more dynamically selected sets for use at the UE 120. The one or more dynamically selected sets may be “dynamically selected” in that the network node 110 may transmit the indication more frequently than RRC-based communications. For example, the indication may be carried in a MAC-CE or a DCI. The network node 110 may transmit the indication in examples where the UE 120 is configured with multiple sets of lower-layer radio link parameters. For example, if the UE 120 is configured with a single set of lower-layer radio link parameters, then the UE 120 may use that set without receiving the indication. In some examples, the indication of the one or more dynamically selected sets may be combined (for example, “clubbed”) with activation or deactivation signaling for UE monitoring and/or prediction. For example, the indication of the one or more dynamically selected sets may activate a monitoring and/or prediction operation at the UE 120 for the one or more dynamically selected sets.

In some aspects, the one or more dynamically selected sets may include one or more autonomously selected sets of the one or more sets of lower-layer radio link parameters. For example, the UE 120 may autonomously select the one or more autonomously selected sets in accordance with QoS network traffic requirements (for example, independently of any input from the network node 110). For example, the UE 120 may be configured with multiple traffic types in addition to the one or more sets of lower-layer radio link parameters, and the one or more autonomously selected sets may correspond to one of the traffic types (for example, a traffic type with stringent QoS requirements).

In some aspects, the UE 120 may generate a prediction result in accordance with the one or more dynamically selected sets of the one or more sets of lower-layer radio link parameters. For example, the UE 120 may perform predictions of, or using, the lower-layer radio link parameters. In some examples, the prediction result may indicate a predicted radio link quality of a radio link between the UE 120 and the network node 110. In some aspects, the UE 120 may generate the prediction result using an AI/ML model. For example, the AI/ML model may be deployed at the UE 120. In some examples, the UE 120 may input, into the AI/ML model, the lower-layer radio link parameters and/or data (e.g., previous measurements) of the lower-layer radio link parameters. In some examples, the AI/ML model may output the prediction result in accordance with the input.

In a second operation 220, the UE 120 may transmit, and the network node 110 may receive, in accordance with the radio link configuration, a channel status report associated with the one or more dynamically selected sets. The channel status report may indicate a radio link quality of one or more channels between the UE 120 and the network node 110. The channel status report may be associated with the one or more dynamically selected sets in that the channel status report may indicate one or more measurement and/or prediction results for the one or more dynamically selected sets. In some examples, the UE 120 may generate the channel status report after performing the monitoring and/or prediction operation. The channel status report may be carried in any suitable container, such as an RRC communication, a MAC-CE, or UCI, among other examples.

In some aspects, the channel status report may indicate whether the one or more dynamically selected sets of the one or more sets of lower-layer radio link parameters include one or more downlink lower-layer radio link parameters, one or more uplink lower-layer radio link parameters, or one or more downlink lower-layer radio link parameters and one or more uplink lower-layer radio link parameters. For example, a predicted link direction of the channel status report may be an uplink direction, a downlink direction, or both the uplink direction and the downlink direction.

In some aspects, the channel status report may indicate one or more parameter set identifiers of the one or more dynamically selected sets. For example, the channel status report may indicate one or more parameter set identifiers for the one or more downlink lower-layer radio link parameters and/or for the one or more uplink lower-layer radio link parameters.

In some aspects, the channel status report may indicate one or more measurement sources or measurement types associated with the one or more dynamically selected sets of the one or more sets of lower-layer radio link parameters. For example, the channel status report may indicate one or more measurement sources or measurement types for the one or more downlink lower-layer radio link parameters and/or for the one or more uplink lower-layer radio link parameters. For example, for the downlink direction, the channel status report may indicate one or more measurement sources or measurement types that include hypothetical BLER, HARQ BLER, or RLC BLER, among other examples. For the uplink direction, the channel status report may indicate one or more measurement sources or measurement types that include HARQ BLER, RLC BLER, uplink transmission delay, MPE, MPR, or an RLC retransmission threshold (for example, a maximum RLC retransmission threshold), among other examples.

In some aspects, the channel status report may indicate one or more measurement results or prediction results associated with the one or more dynamically selected sets of the one or more sets of lower-layer radio link parameters. The one or more measurement results or prediction results may be associated with the one or more dynamically selected sets in that the one or more measurement results or prediction results may be generated using the one or more dynamically selected sets. The channel status report may indicate one or more measurement results or prediction results for the one or more downlink lower-layer radio link parameters and/or for the one or more uplink lower-layer radio link parameters. The one or more measurement (for example, monitoring) results or prediction results may include one or more hard results (for example, a number without a probability or likelihood) and/or one or more soft results (for example, a number with a probability or likelihood).

In some aspects, the channel status report may indicate one or more predicted times associated with the one or more prediction results. The one or more predicted times may be associated with the one or more prediction results in that the one or more prediction results may be predicted to occur at the one or more predicted times. For example, a predicted time may indicate a predicted timing of a prediction result. The channel status report may indicate one or more predicted times for the one or more downlink lower-layer radio link parameters and/or for the one or more uplink lower-layer radio link parameters.

In some aspects, the channel status report may indicate one or more confidence levels associated with the one or more measurement results or prediction results. The one or more confidence levels may be associated with the one or more measurement results or prediction results in that the one or more confidence levels may indicate one or more levels of confidence in the one or more measurement results or prediction results. The channel status report may indicate one or more confidence levels for the one or more downlink lower-layer radio link parameters and/or for the one or more uplink lower-layer radio link parameters.

In some aspects, the UE 120 may transmit, and the network node 110 may receive, an indication of a UE capability associated with the one or more sets of lower-layer radio link parameters. The UE capability may be associated with the one or more sets of lower-layer radio link parameters in that the UE capability may be an ability of the UE 120 to perform one or more operations described herein that involve the one or more sets of lower-layer radio link parameters, such as operations 210 or 220, among other examples. In some examples, the network node 110 may transmit the radio link configuration in accordance with the UE capability. In some examples, the UE capability may indicate a supported quantity of sets of lower-layer radio link parameters. For example, the supported quantity may be greater than or equal to zero. If the supported quantity is zero, then the UE 120 may not support operations described herein that involve the one or more sets of lower-layer radio link parameters. The UE capability may indicate a supported quantity of sets of downlink lower-layer radio link parameters and/or a supported quantity of sets of uplink lower-layer radio link parameters. In some examples, the UE capability may indicate whether the UE 120 supports future prediction and/or past measurement or monitoring. In some examples, the UE capability may indicate one or more supported monitoring types. For example, for downlink, the UE capability may indicate whether the UE 120 supports hypothetical BLER, HARQ BLER, or RLC BLER, among other examples. Additionally or alternatively, for uplink, the UE capability may indicate whether the UE 120 supports HARQ BLER, RLC BLER, delay, MPE, MPR, or an RLC retransmission threshold (for example, a maximum RLC retransmission threshold), among other examples.

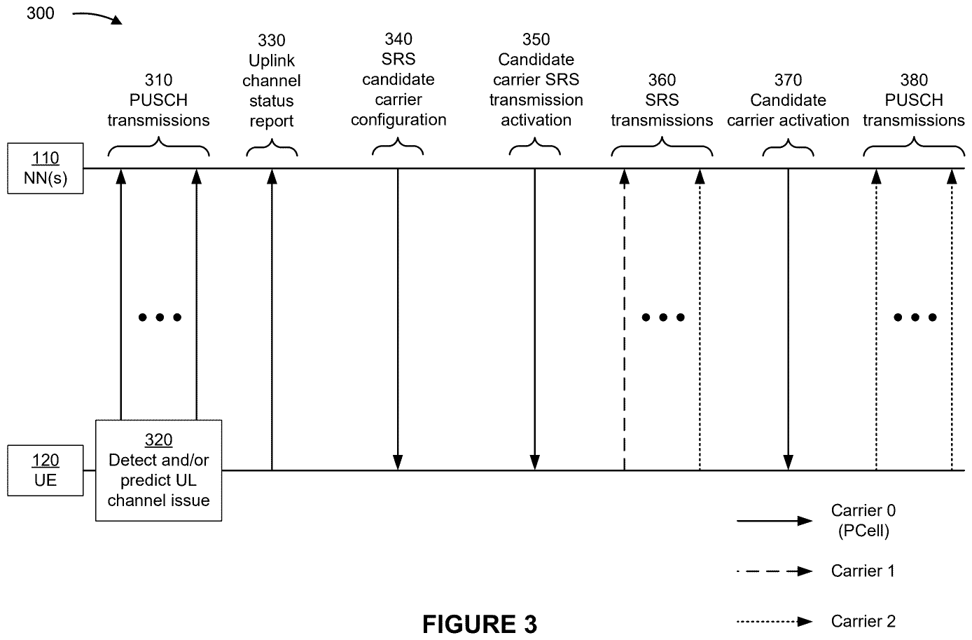

FIG. 3 is a diagram illustrating an example 300 associated with dynamic selection of lower-layer radio link parameters for uplink transmissions, in accordance with the present disclosure. As shown in FIG. 3, a network node 110 and a UE 120 may communicate with one another.

In a first operation 310, the UE 120 may transmit, and the network node 110 may receive, one or more uplink transmissions. For example, the one or more uplink transmissions may be PUSCH transmissions. The one or more uplink transmissions may not have high HARQ or automatic repeat request (ARQ) retransmissions.

In a second operation 320, the UE 120 may detect and/or predict an uplink channel issue. For example, the UE 120 may identify poor uplink channel conditions.

In a third operation 330, the UE 120 may transmit, and the network node 110 may receive, an uplink channel status report. For example, the uplink channel status report may notify the network node 110 of the uplink channel issue. The uplink channel status may or may not indicate or be transmitted in accordance with a radio link prediction.

In a fourth operation 340, the network node 110 may transmit, and the UE 120 may receive, one or more uplink resource configurations associated with one or more secondary carriers or neighboring cells. The one or more uplink resource configurations may be associated with the one or more secondary carriers or neighboring cells in that the one or more uplink resource configurations may configure the UE 120 to transmit one or more uplink transmissions over one or more uplink resources for reception by the one or more secondary carriers or neighboring cells. In some examples, the fourth operation 340 may occur before one or more of operations 310-330 (for example, the network node 110 may transmit the one or more uplink resource configurations before the UE 120 transmits the PUSCH transmissions and/or the uplink channel status report).

In some aspects, the one or more uplink resource configurations may include one or more PUSCH resource configurations, one or more RACH resource configurations, or one or more SRS resource configurations. For example, the uplink resources configured by the uplink resource configurations may include PUSCH resources (for example, dynamic grant (DG) resources or configured grant (CG) resources), RACH resources, or SRS resources. For example, the one or more uplink resource configurations may be an SRS resource configuration for candidate carriers.

In some aspects, the one or more uplink resource configurations may be carrier-specific or cell-specific. For example, the one or more uplink resources (for example, one or more SRS resources) may be configured by the one or more uplink resource configurations on a per-carrier basis or a per-cell basis.

In a fifth operation 350, the network node 110 may transmit, and the UE 120 may receive, a candidate carrier uplink transmission activation. For example, the candidate carrier uplink transmission activation may activate uplink transmission (for example, SRS transmission) to one or more candidate carriers (for example, secondary carriers).

In a sixth operation 360, the UE 120 may transmit, and the one or more candidate carriers or secondary cells (for example, neighbor cells) may receive, one or more uplink communications in accordance with the one or more uplink resource configurations and the one or more dynamically selected sets of the one or more sets of lower-layer radio link parameters. For example, the UE 120 may transmit the one or more uplink communications responsive to transmitting the uplink channel status report (for example, rather than transmitting the uplink communication(s) continuously). In some examples, the UE 120 may autonomously transmit the one or more uplink communications. In some examples, the UE 120 may transmit the one or more uplink communications responsive to a signal (for example, a MAC-CE or a DCI) received from the network node 110 that triggers transmission of the one or more uplink communications. In example 300, the network node 110 handles communications over a primary carrier 0 on a primary cell (PCell), over carrier 1, and over carrier 2. Carriers 1 and 2 are secondary carriers that may receive the one or more uplink communications.

In some aspects, the one or more secondary carriers may be in an inactivated state. For example, the one or more secondary carriers that receive the one or more uplink communications (for example, carriers 1 and 2) may not be activated for handling of uplink data from the UE 120.

In some aspects, the network node 110 may receive one or more uplink measurement results in accordance with the one or more uplink resource configurations and the one or more dynamically selected sets of the one or more sets of lower-layer radio link parameters. For example, the one or more candidate carriers or secondary cells may generate the one or more uplink measurement results using the one or more uplink communications and transmit the one or more uplink measurement results to the network node 110. For example, if the UE 120 transmits one or more uplink SRS transmissions to one or more secondary (for example, neighboring) cells, then the network node 110 (for example, the serving cell) and the one or more secondary cells may exchange SRS resource information and SRS measurement results over a network (for example, over an Xn interface).

In a seventh operation 370, the network node 110 may transmit, and the UE 120 may receive, in accordance with the one or more uplink communications, an indication of a selected secondary carrier or neighboring cell of the one or more secondary carriers or neighboring cells. For example, the network node 110 may select the selected secondary carrier or neighboring cell in accordance with the one or more uplink measurement results. For example, the network node 110 may identify which secondary carrier or neighboring cell provides a required channel quality (with respect to a QoS requirement) in the uplink. In example 300, the indication may include an activation of a selected candidate carrier (for example, a selected secondary carrier). In some examples, the indication may trigger the UE 120 to transmit control traffic using the selected secondary carrier or neighboring cell. The indication may be carried via MAC-CE or DCI, among other examples. In some examples, the network node 110 may prepare for traffic re-routing through the selected secondary carrier or neighboring cell (for example, by participating in a handover procedure).

In an eighth operation 380, the UE 120 may transmit one or more uplink transmissions. For example, the one or more uplink transmissions may be PUSCH transmissions that are transmitted to the newly-activated, selected secondary carrier.

The channel status report associated with one or more dynamically selected sets may enable QoS-specific UE radio link quality reporting. For example, the channel status report may enable radio-bearer-specific radio link monitoring and/or prediction in the downlink and/or the uplink for proactive support of QoS in a RAN. For example, the dynamically selected sets may enable the UE 120 to monitor and/or predict whether QoS requirements are met for different types of traffic (which may have different Qos requirements). As a result, the channel status report may help to avoid unnecessary BFD or RLF operations, thereby conserving processing and/or memory resources. Additionally or alternatively, the channel status report may help to trigger BFD or RLF operations that improve radio link quality in accordance with QoS requirements.

The indication of the selected secondary carrier or neighboring cell may help to resolve degraded radio link quality. For example, the network node 110 may identify an uplink secondary carrier or neighboring cell that can support improved radio uplink quality, thereby helping to improve uplink transmission success, reduce uplink retransmissions, and conserve processing and/or memory resources.

FIG. 4 is a flowchart illustrating an example process 400 performed, for example, at a UE or an apparatus of a UE that supports dynamic selection of lower-layer link parameters in accordance with the present disclosure. Example process 400 is an example where the apparatus or the UE (for example, UE 120) performs operations associated with dynamic selection of lower-layer radio link parameters.

As shown in FIG. 4, in some aspects, process 400 may include receiving a radio link configuration of one or more sets of lower-layer radio link parameters (block 410). For example, the UE (such as by using communication manager 150 or reception component 602, depicted in FIG. 6) may receive a radio link configuration of one or more sets of lower-layer radio link parameters, as described above.

As further shown in FIG. 4, in some aspects, process 400 may include transmitting, in accordance with the radio link configuration, a channel status report associated with one or more dynamically selected sets of the one or more sets of lower-layer radio link parameters (block 420). For example, the UE (such as by using communication manager 150 or transmission component 604, depicted in FIG. 6) may transmit, in accordance with the radio link configuration, a channel status report associated with one or more dynamically selected sets of the one or more sets of lower-layer radio link parameters, as described above.

Process 400 may include additional aspects, such as any single aspect or any combination of aspects described below or in connection with one or more other processes described elsewhere herein.

In a first additional aspect, the one or more sets of lower-layer radio link parameters are bandwidth-part-specific, cell-specific, or carrier-specific.

In a second additional aspect, alone or in combination with the first aspect, the one or more sets of lower-layer radio link parameters include one or more downlink lower-layer radio link parameters.

In a third additional aspect, alone or in combination with one or more of the first and second aspects, the one or more downlink lower-layer radio link parameters include one or more of a prediction time window, one or more PDCCH parameters associated with one or more hypothetical PDCCH BLERs, one or more reference signal parameters associated with the one or more hypothetical PDCCH BLERs, an evaluation time window, one or more RNTIs associated with one or more HARQ BLERs, or one or more radio bearer identifiers or logical channel identifiers associated with one or more RLC BLERs.

In a fourth additional aspect, alone or in combination with one or more of the first through third aspects, the radio link configuration indicates one or more downlink lower-layer radio link parameter thresholds associated with the one or more downlink lower-layer radio link parameters, and the one or more downlink lower-layer radio link parameter thresholds include one or more of a hypothetical PDCCH BLER threshold, a counter threshold associated with the PDCCH BLER threshold, a HARQ BLER threshold, or an RLC BLER threshold.

In a fifth additional aspect, alone or in combination with one or more of the first through fourth aspects, the one or more sets of lower-layer radio link parameters include one or more uplink lower-layer radio link parameters.

In a sixth additional aspect, alone or in combination with one or more of the first through fifth aspects, the one or more uplink lower-layer radio link parameters include one or more of a prediction time window, an MPE, an MPR, one or more RNTIs associated with one or more HARQ BLERs, one or more radio bearer identifiers or logical channel identifiers associated with one or more RLC BLERs, or one or more radio bearer identifiers or logical channel identifiers associated with uplink transmission delay.

In a seventh additional aspect, alone or in combination with one or more of the first through sixth aspects, the radio link configuration indicates one or more uplink lower-layer radio link parameter thresholds associated with the one or more uplink lower-layer radio link parameters, and the one or more uplink lower-layer radio link parameter thresholds include one or more of a HARQ BLER threshold, an RLC BLER threshold, an MPE threshold, an MPR threshold, an uplink transmission delay threshold, or an RLC retransmission threshold.

In an eighth additional aspect, alone or in combination with one or more of the first through seventh aspects, process 400 includes receiving an indication of the one or more dynamically selected sets of the one or more sets of lower-layer radio link parameters.

In a ninth additional aspect, alone or in combination with one or more of the first through eighth aspects, the one or more dynamically selected sets comprise one or more autonomously selected sets of the one or more sets of lower-layer radio link parameters.

In a tenth additional aspect, alone or in combination with one or more of the first through ninth aspects, the channel status report indicates whether the one or more dynamically selected sets of the one or more sets of lower-layer radio link parameters include one or more downlink lower-layer radio link parameters, one or more uplink lower-layer radio link parameters, or one or more downlink lower-layer radio link parameters and one or more uplink lower-layer radio link parameters.

In an eleventh additional aspect, alone or in combination with one or more of the first through tenth aspects, the channel status report indicates one or more of one or more parameter set identifiers of the one or more dynamically selected sets of the one or more sets of lower-layer radio link parameters, one or more measurement sources or measurement types associated with the one or more dynamically selected sets of the one or more sets of lower-layer radio link parameters, one or more measurement results or prediction results associated with the one or more dynamically selected sets of the one or more sets of lower-layer radio link parameters, one or more predicted times associated with the one or more prediction results, or one or more confidence levels associated with the one or more measurement results or prediction results.

In a twelfth additional aspect, alone or in combination with one or more of the first through eleventh aspects, process 400 includes receiving one or more uplink resource configurations associated with one or more secondary carriers or neighboring cells, transmitting one or more uplink communications in accordance with the one or more uplink resource configurations and the one or more dynamically selected sets of the one or more sets of lower-layer radio link parameters, and receiving, in accordance with the one or more uplink communications, an indication of a selected secondary carrier or neighboring cell of the one or more secondary carriers or neighboring cells.

In a thirteenth additional aspect, alone or in combination with one or more of the first through twelfth aspects, the one or more uplink resource configurations include one or more PUSCH resource configurations, one or more RACH resource configurations, or one or more SRS resource configurations.

In a fourteenth additional aspect, alone or in combination with one or more of the first through thirteenth aspects, the one or more uplink resource configurations are carrier-specific or cell-specific.

In a fifteenth additional aspect, alone or in combination with one or more of the first through fourteenth aspects, the one or more secondary carriers are in an inactivated state.

In a sixteenth additional aspect, alone or in combination with one or more of the first through fifteenth aspects, process 400 includes transmitting an indication of a UE capability associated with the one or more sets of lower-layer radio link parameters.

In a seventeenth additional aspect, alone or in combination with one or more of the first through sixteenth aspects, process 400 includes generating a prediction result in accordance with the one or more dynamically selected sets of the one or more sets of lower-layer radio link parameters.

In an eighteenth additional aspect, alone or in combination with one or more of the first through seventeenth aspects, generating the prediction result includes generating the prediction result using an AI/ML model.

Although FIG. 4 shows example blocks of process 400, in some aspects, process 400 may include additional blocks, fewer blocks, different blocks, or differently arranged blocks than those depicted in FIG. 4. Additionally or alternatively, two or more of the blocks of process 400 may be performed in parallel.

FIG. 5 is a flowchart illustrating an example process 500 performed, for example, at a network node or an apparatus of a network node that supports dynamic selection of lower-layer link parameters in accordance with the present disclosure. Example process 500 is an example where the apparatus or the network node (for example, network node 110) performs operations associated with dynamic selection of lower-layer radio link parameters.

As shown in FIG. 5, in some aspects, process 500 may include transmitting a radio link configuration of one or more sets of lower-layer radio link parameters (block 510). For example, the network node (such as by using communication manager 150 or transmission component 704, depicted in FIG. 7) may transmit a radio link configuration of one or more sets of lower-layer radio link parameters, as described above.

As further shown in FIG. 5, in some aspects, process 500 may include receiving, in accordance with the radio link configuration, a channel status report associated with one or more dynamically selected sets of the one or more sets of lower-layer radio link parameters (block 520). For example, the network node (such as by using communication manager 150 or reception component 702, depicted in FIG. 7) may receive, in accordance with the radio link configuration, a channel status report associated with one or more dynamically selected sets of the one or more sets of lower-layer radio link parameters, as described above.

Process 500 may include additional aspects, such as any single aspect or any combination of aspects described below or in connection with one or more other processes described elsewhere herein.

In a first additional aspect, the one or more sets of lower-layer radio link parameters are bandwidth-part-specific, cell-specific, or carrier-specific.

In a second additional aspect, alone or in combination with the first aspect, the one or more sets of lower-layer radio link parameters include one or more downlink lower-layer radio link parameters.

In a third additional aspect, alone or in combination with one or more of the first and second aspects, the one or more downlink lower-layer radio link parameters include one or more of a prediction time window associated with the one or more downlink lower-layer radio link parameters, one or more PDCCH parameters associated with one or more hypothetical PDCCH BLERs, one or more reference signal parameters associated with the one or more hypothetical PDCCH BLERs, an evaluation time window associated with the one or more downlink lower-layer radio link parameters, one or more RNTIs associated with one or more HARQ BLERs, or one or more radio bearer identifiers or logical channel identifiers associated with one or more RLC BLERs.

In a fourth additional aspect, alone or in combination with one or more of the first through third aspects, the radio link configuration indicates one or more downlink lower-layer radio link parameter thresholds associated with the one or more downlink lower-layer radio link parameters, and the one or more downlink lower-layer radio link parameter thresholds include one or more of a hypothetical PDCCH BLER threshold, a counter threshold associated with the PDCCH BLER threshold, a HARQ BLER threshold, or an RLC BLER threshold.

In a fifth additional aspect, alone or in combination with one or more of the first through fourth aspects, the one or more sets of lower-layer radio link parameters include one or more uplink lower-layer radio link parameters.

In a sixth additional aspect, alone or in combination with one or more of the first through fifth aspects, the one or more uplink lower-layer radio link parameters include one or more of a prediction time window associated with the one or more uplink lower-layer radio link parameters, an MPE, an MPR, one or more RNTIs associated with one or more HARQ BLERs, one or more radio bearer identifiers or logical channel identifiers associated with one or more RLC BLERs, or one or more radio bearer identifiers or logical channel identifiers associated with uplink transmission delay.

In a seventh additional aspect, alone or in combination with one or more of the first through sixth aspects, the radio link configuration indicates one or more uplink lower-layer radio link parameter thresholds associated with the one or more uplink lower-layer radio link parameters, and the one or more uplink lower-layer radio link parameter thresholds include one or more of a HARQ BLER threshold, an RLC BLER threshold, an MPE threshold, an MPR threshold, an uplink transmission delay threshold, or an RLC retransmission threshold.

In an eighth additional aspect, alone or in combination with one or more of the first through seventh aspects, process 500 includes transmitting an indication of the one or more dynamically selected sets of the one or more sets of lower-layer radio link parameters.

In a ninth additional aspect, alone or in combination with one or more of the first through eighth aspects, the one or more dynamically selected sets comprise one or more autonomously selected sets of the one or more sets of lower-layer radio link parameters.

In a tenth additional aspect, alone or in combination with one or more of the first through ninth aspects, the channel status report indicates whether the one or more dynamically selected sets of the one or more sets of lower-layer radio link parameters include one or more downlink lower-layer radio link parameters, one or more uplink lower-layer radio link parameters, or one or more downlink lower-layer radio link parameters and one or more uplink lower-layer radio link parameters.

In an eleventh additional aspect, alone or in combination with one or more of the first through tenth aspects, the channel status report indicates one or more of one or more parameter set identifiers of the one or more dynamically selected sets of the one or more sets of lower-layer radio link parameters, one or more measurement sources or measurement types associated with the one or more dynamically selected sets of the one or more sets of lower-layer radio link parameters, one or more measurement results or prediction results associated with the one or more dynamically selected sets of the one or more sets of lower-layer radio link parameters, one or more predicted times associated with the one or more prediction results, or one or more confidence levels associated with the one or more measurement results or prediction results.

In a twelfth additional aspect, alone or in combination with one or more of the first through eleventh aspects, process 500 includes transmitting one or more uplink resource configurations associated with one or more secondary carriers or neighboring cells, receiving one or more uplink measurement results in accordance with the one or more uplink resource configurations and the one or more dynamically selected sets of the one or more sets of lower-layer radio link parameters, and transmitting, in accordance with the one or more uplink measurement results, an indication of a selected secondary carrier or neighboring cell of the one or more secondary carriers or neighboring cells.

In a thirteenth additional aspect, alone or in combination with one or more of the first through twelfth aspects, the one or more uplink resource configurations include one or more PUSCH resource configurations, one or more RACH resource configurations, or one or more SRS resource configurations.

In a fourteenth additional aspect, alone or in combination with one or more of the first through thirteenth aspects, the one or more uplink resource configurations are carrier-specific or cell-specific.

In a fifteenth additional aspect, alone or in combination with one or more of the first through fourteenth aspects, the one or more secondary carriers are in an inactivated state.

In a sixteenth additional aspect, alone or in combination with one or more of the first through fifteenth aspects, process 500 includes receiving an indication of a UE capability associated with the one or more sets of lower-layer radio link parameters.

Although FIG. 5 shows example blocks of process 500, in some aspects, process 500 may include additional blocks, fewer blocks, different blocks, or differently arranged blocks than those depicted in FIG. 5. Additionally or alternatively, two or more of the blocks of process 500 may be performed in parallel.

FIG. 6 is a diagram of an example apparatus 600 for wireless communication that supports dynamic selection of lower-layer link parameters in accordance with the present disclosure. The apparatus 600 may be a UE, or a UE may include the apparatus 600. In some aspects, the apparatus 600 includes a reception component 602, a transmission component 604, and a communication manager 606, which may be in communication with one another (for example, via one or more buses). As shown, the apparatus 600 may communicate with another apparatus 608 (such as a UE 120, a network node 110, or another wireless communication device) using the reception component 602 and the transmission component 604. The communication manager 606 may be included in, or implemented via, a processing system (for example, the processing system 140). In some aspects, the communication manager 606 is the communication manager 150.

In some aspects, the apparatus 600 may be configured to and/or operable to perform one or more operations described herein in connection with FIGS. 2-3. Additionally or alternatively, the apparatus 600 may be configured to and/or operable to perform one or more processes described herein, such as process 400 of FIG. 4.

The reception component 602 may receive communications, such as reference signals, control information, and/or data communications, from the apparatus 608. The reception component 602 may provide received communications to one or more other components of the apparatus 600, such as the communication manager 606. In some aspects, the reception component 602 may perform signal processing on the received communications, and may provide the processed signals to the one or more other components in a similar manner as described above in connection with FIG. 1. In some aspects, the reception component 602 may include one or more components of the UE described above in connection with FIG. 1, such as a radio, one or more RF chains, one or more transceivers, or one or more modems, each of which may in turn be coupled with one or more antennas of the UE.

The transmission component 604 may transmit communications, such as reference signals, control information, and/or data communications, to the apparatus 608. In some aspects, the communication manager 606 may generate communications and may transmit the generated communications to the transmission component 604 for transmission to the apparatus 608. In some aspects, the transmission component 604 may perform signal processing on the generated communications, and may transmit the processed signals to the apparatus 608 in a similar manner as described above in connection with FIG. 1. In some aspects, the transmission component 604 may include one or more components of the UE described above in connection with FIG. 1, such as a radio, one or more RF chains, one or more transceivers, or one or more modems, each of which may in turn be coupled with one or more antennas of the UE. In some aspects, the transmission component 604 may be co-located with the reception component 602.

The communication manager 606 may receive or may cause the reception component 602 to receive a radio link configuration of one or more sets of lower-layer radio link parameters. The communication manager 606 may transmit or may cause the transmission component 604 to transmit, in accordance with the radio link configuration, a channel status report associated with one or more dynamically selected sets of the one or more sets of lower-layer radio link parameters. In some aspects, the communication manager 606 may perform one or more operations described elsewhere herein as being performed by one or more components of the communication manager 606.

The reception component 602 may receive a radio link configuration of one or more sets of lower-layer radio link parameters. The transmission component 604 may transmit, in accordance with the radio link configuration, a channel status report associated with one or more dynamically selected sets of the one or more sets of lower-layer radio link parameters. In some aspects, the reception component 602 may receive an indication of the one or more dynamically selected sets of the one or more sets of lower-layer radio link parameters. In some aspects, the reception component 602 may receive one or more uplink resource configurations associated with one or more secondary carriers or neighboring cells. In some aspects, the transmission component 604 may transmit one or more uplink communications in accordance with the one or more uplink resource configurations and the one or more dynamically selected sets of the one or more sets of lower-layer radio link parameters. In some aspects, the reception component 602 may receive, in accordance with the one or more uplink communications, an indication of a selected secondary carrier or neighboring cell of the one or more secondary carriers or neighboring cells. In some aspects, the transmission component 604 may transmit an indication of a UE capability associated with the one or more sets of lower-layer radio link parameters.

The quantity and arrangement of components shown in FIG. 6 are provided as an example. In practice, there may be additional components, fewer components, different components, or differently arranged components than those shown in FIG. 6. Furthermore, two or more components shown in FIG. 6 may be implemented within a single component, or a single component shown in FIG. 6 may be implemented as multiple, distributed components. Additionally or alternatively, a set of (one or more) components shown in FIG. 6 may perform one or more functions described as being performed by another set of components shown in FIG. 6.

FIG. 7 is a diagram of an example apparatus 700 for wireless communication that supports dynamic selection of lower-layer link parameters in accordance with the present disclosure. The apparatus 700 may be a network node, or a network node may include the apparatus 700. In some aspects, the apparatus 700 includes a reception component 702, a transmission component 704, and a communication manager 706, which may be in communication with one another (for example, via one or more buses). As shown, the apparatus 700 may communicate with another apparatus 708 (such as a UE 120, a network node 110, or another wireless communication device) using the reception component 702 and the transmission component 704. The communication manager 706 may be included in, or implemented via, a processing system (for example, the processing system 145). In some aspects, the communication manager 706 is the communication manager 155

In some aspects, the apparatus 700 may be configured to and/or operable to perform one or more operations described herein in connection with FIGS. 2-3. Additionally or alternatively, the apparatus 700 may be configured to and/or operable to perform one or more processes described herein, such as process 500 of FIG. 5.

The reception component 702 may receive communications, such as reference signals, control information, and/or data communications, from the apparatus 708. The reception component 702 may provide received communications to one or more other components of the apparatus 700, such as the communication manager 706. In some aspects, the reception component 702 may perform signal processing on the received communications, and may provide the processed signals to the one or more other components in a similar manner as described above in connection with FIG. 1. In some aspects, the reception component 702 may include one or more components of the network node described above in connection with FIG. 1, such as a radio, one or more RF chains, one or more transceivers, or one or more modems, each of which may in turn be coupled with one or more antennas of the network node.

The transmission component 704 may transmit communications, such as reference signals, control information, and/or data communications, to the apparatus 708. In some aspects, the communication manager 706 may generate communications and may transmit the generated communications to the transmission component 704 for transmission to the apparatus 708. In some aspects, the transmission component 704 may perform signal processing on the generated communications, and may transmit the processed signals to the apparatus 708 in a similar manner as described above in connection with FIG. 1. In some aspects, the transmission component 704 may include one or more components of the network node described above in connection with FIG. 1, such as a radio, one or more RF chains, one or more transceivers, or one or more modems, each of which may in turn be coupled with one or more antennas of the network node. In some aspects, the transmission component 704 may be co-located with the reception component 702.

The communication manager 706 may transmit or may cause the transmission component 704 to transmit a radio link configuration of one or more sets of lower-layer radio link parameters. The communication manager 706 may receive or may cause the reception component 702 to receive, in accordance with the radio link configuration, a channel status report associated with one or more dynamically selected sets of the one or more sets of lower-layer radio link parameters. In some aspects, the communication manager 706 may perform one or more operations described elsewhere herein as being performed by one or more components of the communication manager 706.

The transmission component 704 may transmit a radio link configuration of one or more sets of lower-layer radio link parameters. The reception component 702 may receive, in accordance with the radio link configuration, a channel status report associated with one or more dynamically selected sets of the one or more sets of lower-layer radio link parameters. In some aspects, the transmission component 704 may transmit an indication of the one or more dynamically selected sets of the one or more sets of lower-layer radio link parameters. In some aspects, the transmission component 704 may transmit one or more uplink resource configurations associated with one or more secondary carriers or neighboring cells. In some aspects, the reception component 702 may receive one or more uplink measurement results in accordance with the one or more uplink resource configurations and the one or more dynamically selected sets of the one or more sets of lower-layer radio link parameters. In some aspects, the transmission component 704 may transmit, in accordance with the one or more uplink measurement results, an indication of a selected secondary carrier or neighboring cell of the one or more secondary carriers or neighboring cells. In some aspects, the reception component 702 may receive an indication of a UE capability associated with the one or more sets of lower-layer radio link parameters.

The quantity and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally or alternatively, a set of (one or more) components shown in FIG. 7 may perform one or more functions described as being performed by another set of components shown in FIG. 7.

The following provides an overview of some Aspects of the present disclosure:
Aspect 1: A method of wireless communication performed by a user equipment (UE), comprising: receiving a radio link configuration of one or more sets of lower-layer radio link parameters; and transmitting, in accordance with the radio link configuration, a channel status report associated with one or more dynamically selected sets of the one or more sets of lower-layer radio link parameters.
Aspect 2: The method of Aspect 1, wherein the one or more sets of lower-layer radio link parameters are bandwidth-part-specific, cell-specific, or carrier-specific.
Aspect 3: The method of any of Aspects 1-2, wherein the one or more sets of lower-layer radio link parameters include one or more downlink lower-layer radio link parameters.
Aspect 4: The method of Aspect 3, wherein the one or more downlink lower-layer radio link parameters include one or more of: a prediction time window, one or more physical downlink control channel (PDCCH) parameters associated with one or more hypothetical PDCCH block error rates (BLERs), one or more reference signal parameters associated with the one or more hypothetical PDCCH BLERs, an evaluation time window, one or more radio network temporary identifiers (RNTIs) associated with one or more hybrid automatic repeat request (HARQ) BLERs, or one or more radio bearer identifiers or logical channel identifiers associated with one or more radio link control (RLC) BLERs.
Aspect 5: The method of Aspect 3, wherein the radio link configuration indicates one or more downlink lower-layer radio link parameter thresholds associated with the one or more downlink lower-layer radio link parameters, and wherein the one or more downlink lower-layer radio link parameter thresholds include one or more of: a hypothetical physical downlink control channel (PDCCH) block error rate (BLER) threshold, a counter threshold associated with the PDCCH BLER threshold, a hybrid automatic repeat request (HARQ) BLER threshold, or a radio link control (RLC) BLER threshold.
Aspect 6: The method of any of Aspects 1-5, wherein the one or more sets of lower-layer radio link parameters include one or more uplink lower-layer radio link parameters.
Aspect 7: The method of Aspect 6, wherein the one or more uplink lower-layer radio link parameters include one or more of: a prediction time window, a maximum permissible exposure (MPE), a maximum power reduction (MPR), one or more radio network temporary identifiers (RNTIs) associated with one or more hybrid automatic repeat request (HARQ) block error rates (BLERs), one or more radio bearer identifiers or logical channel identifiers associated with one or more radio link control (RLC) BLERs, or one or more radio bearer identifiers or logical channel identifiers associated with uplink transmission delay.
Aspect 8: The method of Aspect 6, wherein the radio link configuration indicates one or more uplink lower-layer radio link parameter thresholds associated with the one or more uplink lower-layer radio link parameters, and wherein the one or more uplink lower-layer radio link parameter thresholds include one or more of: a hybrid automatic repeat request (HARQ) block error rate (BLER) threshold, a radio link control (RLC) BLER threshold, a maximum permissible exposure (MPE) threshold, a maximum power reduction (MPR) threshold, an uplink transmission delay threshold, or an RLC retransmission threshold.
Aspect 9: The method of any of Aspects 1-8, further comprising: receiving an indication of the one or more dynamically selected sets of the one or more sets of lower-layer radio link parameters.
Aspect 10: The method of any of Aspects 1-9, wherein the one or more dynamically selected sets comprise one or more autonomously selected sets of the one or more sets of lower-layer radio link parameters.
Aspect 11: The method of any of Aspects 1-10, wherein the channel status report indicates whether the one or more dynamically selected sets of the one or more sets of lower-layer radio link parameters include one or more downlink lower-layer radio link parameters, one or more uplink lower-layer radio link parameters, or one or more downlink lower-layer radio link parameters and one or more uplink lower-layer radio link parameters.
Aspect 12: The method of any of Aspects 1-11, wherein the channel status report indicates one or more of: one or more parameter set identifiers of the one or more dynamically selected sets of the one or more sets of lower-layer radio link parameters, one or more measurement sources or measurement types associated with the one or more dynamically selected sets of the one or more sets of lower-layer radio link parameters, one or more measurement results or prediction results associated with the one or more dynamically selected sets of the one or more sets of lower-layer radio link parameters, one or more predicted times associated with the one or more prediction results, or one or more confidence levels associated with the one or more measurement results or prediction results.
Aspect 13: The method of any of Aspects 1-12, further comprising: receiving one or more uplink resource configurations associated with one or more secondary carriers or neighboring cells; transmitting one or more uplink communications in accordance with the one or more uplink resource configurations and the one or more dynamically selected sets of the one or more sets of lower-layer radio link parameters; and receiving, in accordance with the one or more uplink communications, an indication of a selected secondary carrier or neighboring cell of the one or more secondary carriers or neighboring cells.
Aspect 14: The method of Aspect 13, wherein the one or more uplink resource configurations include one or more physical uplink shared channel (PUSCH) resource configurations, one or more random access channel (RACH) resource configurations, or one or more sounding reference signal (SRS) resource configurations.
Aspect 15: The method of Aspect 13, wherein the one or more uplink resource configurations are carrier-specific or cell-specific.
Aspect 16: The method of Aspect 13, wherein the one or more secondary carriers are in an inactivated state.
Aspect 17: The method of any of Aspects 1-16, further comprising: transmitting an indication of a UE capability associated with the one or more sets of lower-layer radio link parameters.
Aspect 18: A method of wireless communication performed by a network node, comprising: transmitting a radio link configuration of one or more sets of lower-layer radio link parameters; and receiving, in accordance with the radio link configuration, a channel status report associated with one or more dynamically selected sets of the one or more sets of lower-layer radio link parameters.
Aspect 19: The method of Aspect 18, wherein the one or more sets of lower-layer radio link parameters are bandwidth-part-specific, cell-specific, or carrier-specific.
Aspect 20: The method of any of Aspects 18-19, wherein the one or more sets of lower-layer radio link parameters include one or more downlink lower-layer radio link parameters.
Aspect 21: The method of Aspect 20, wherein the one or more downlink lower-layer radio link parameters include one or more of: a prediction time window associated with the one or more downlink lower-layer radio link parameters, one or more physical downlink control channel (PDCCH) parameters associated with one or more hypothetical PDCCH block error rates (BLERs), one or more reference signal parameters associated with the one or more hypothetical PDCCH BLERs, an evaluation time window associated with the one or more downlink lower-layer radio link parameters, one or more radio network temporary identifiers (RNTIs) associated with one or more hybrid automatic repeat request (HARQ) BLERs, or one or more radio bearer identifiers or logical channel identifiers associated with one or more radio link control (RLC) BLERs.
Aspect 22: The method of Aspect 20, wherein the radio link configuration indicates one or more downlink lower-layer radio link parameter thresholds associated with the one or more downlink lower-layer radio link parameters, and wherein the one or more downlink lower-layer radio link parameter thresholds include one or more of: a hypothetical physical downlink control channel (PDCCH) block error rate (BLER) threshold, a counter threshold associated with the PDCCH BLER threshold, a hybrid automatic repeat request (HARQ) BLER threshold, or a radio link control (RLC) BLER threshold.
Aspect 23: The method of any of Aspects 18-22, wherein the one or more sets of lower-layer radio link parameters include one or more uplink lower-layer radio link parameters.
Aspect 24: The method of Aspect 23, wherein the one or more uplink lower-layer radio link parameters include one or more of: a prediction time window associated with the one or more uplink lower-layer radio link parameters, a maximum permissible exposure (MPE), a maximum power reduction (MPR), one or more radio network temporary identifiers (RNTIs) associated with one or more hybrid automatic repeat request (HARQ) block error rates (BLERs), one or more radio bearer identifiers or logical channel identifiers associated with one or more radio link control (RLC) BLERs, or one or more radio bearer identifiers or logical channel identifiers associated with uplink transmission delay.
Aspect 25: The method of Aspect 23, wherein the radio link configuration indicates one or more uplink lower-layer radio link parameter thresholds associated with the one or more uplink lower-layer radio link parameters, and wherein the one or more uplink lower-layer radio link parameter thresholds include one or more of: a hybrid automatic repeat request (HARQ) block error rate (BLER) threshold, a radio link control (RLC) BLER threshold, a maximum permissible exposure (MPE) threshold, a maximum power reduction (MPR) threshold, an uplink transmission delay threshold, or an RLC retransmission threshold.
Aspect 26: The method of any of Aspects 18-25, further comprising: transmitting an indication of the one or more dynamically selected sets of the one or more sets of lower-layer radio link parameters.
Aspect 27: The method of any of Aspects 18-26, wherein the one or more dynamically selected sets comprise one or more autonomously selected sets of the one or more sets of lower-layer radio link parameters.
Aspect 28: The method of any of Aspects 18-27, wherein the channel status report indicates whether the one or more dynamically selected sets of the one or more sets of lower-layer radio link parameters include one or more downlink lower-layer radio link parameters, one or more uplink lower-layer radio link parameters, or one or more downlink lower-layer radio link parameters and one or more uplink lower-layer radio link parameters.
Aspect 29: The method of any of Aspects 18-28, wherein the channel status report indicates one or more of: one or more parameter set identifiers of the one or more dynamically selected sets of the one or more sets of lower-layer radio link parameters, one or more measurement sources or measurement types associated with the one or more dynamically selected sets of the one or more sets of lower-layer radio link parameters, one or more measurement results or prediction results associated with the one or more dynamically selected sets of the one or more sets of lower-layer radio link parameters, one or more predicted times associated with the one or more prediction results, or one or more confidence levels associated with the one or more measurement results or prediction results.
Aspect 30: The method of any of Aspects 18-29, further comprising: transmitting one or more uplink resource configurations associated with one or more secondary carriers or neighboring cells; receiving one or more uplink measurement results in accordance with the one or more uplink resource configurations and the one or more dynamically selected sets of the one or more sets of lower-layer radio link parameters; and transmitting, in accordance with the one or more uplink measurement results, an indication of a selected secondary carrier or neighboring cell of the one or more secondary carriers or neighboring cells.
Aspect 31: The method of Aspect 30, wherein the one or more uplink resource configurations include one or more physical uplink shared channel (PUSCH) resource configurations, one or more random access channel (RACH) resource configurations, or one or more sounding reference signal (SRS) resource configurations.
Aspect 32: The method of Aspect 30, wherein the one or more uplink resource configurations are carrier-specific or cell-specific.
Aspect 33: The method of Aspect 30, wherein the one or more secondary carriers are in an inactivated state.
Aspect 34: The method of any of Aspects 18-33, further comprising: receiving an indication of a UE capability associated with the one or more sets of lower-layer radio link parameters.
Aspect 35: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-34 or 42-43.
Aspect 36: An apparatus for wireless communication at a device, the apparatus comprising one or more memories and one or more processors coupled to the one or more memories, the one or more processors configured to cause the device to perform the method of one or more of Aspects 1-34 or 42-43.
Aspect 37: An apparatus for wireless communication, the apparatus comprising at least one means for performing the method of one or more of Aspects 1-34 or 42-43.
Aspect 38: A non-transitory computer-readable medium storing code for wireless communication, the code comprising instructions executable by one or more processors to perform the method of one or more of Aspects 1-34 or 42-43.
Aspect 39: A non-transitory computer-readable medium storing a set of instructions for wireless communication, the set of instructions comprising one or more instructions that, when executed by one or more processors of a device, cause the device to perform the method of one or more of Aspects 1-34 or 42-43.
Aspect 40: A device for wireless communication, the device comprising a processing system that includes one or more processors and one or more memories coupled with the one or more processors, the processing system configured to cause the device to perform the method of one or more of Aspects 1-34 or 42-43.
Aspect 41: An apparatus for wireless communication at a device, the apparatus comprising one or more memories and one or more processors coupled to the one or more memories, the one or more processors individually or collectively configured to cause the device to perform the method of one or more of Aspects 1-34 or 42-43.
Aspect 42: The method of any of Aspects 1-16, further comprising: generating a prediction result in accordance with the one or more dynamically selected sets of the one or more sets of lower-layer radio link parameters.
Aspect 43: The method of Aspect 42, wherein generating the prediction result includes generating the prediction result using an artificial intelligence or machine learning (AI/ML) model.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a +a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories storing processor-executable code; and
one or more processors coupled with the one or more memories, at least one processor of the one or more processors configured to cause the UE to:
receive a radio link configuration of one or more sets of lower-layer radio link parameters; and
transmit, in accordance with the radio link configuration, a channel status report associated with one or more dynamically selected sets of the one or more sets of lower-layer radio link parameters.

2. The apparatus of claim 1, wherein the one or more sets of lower-layer radio link parameters are bandwidth-part-specific, cell-specific, or carrier-specific.

3. The apparatus of claim 1, wherein the one or more sets of lower-layer radio link parameters include one or more downlink lower-layer radio link parameters.

4. The apparatus of claim 3, wherein the one or more downlink lower-layer radio link parameters include one or more of:
a prediction time window,
one or more physical downlink control channel (PDCCH) parameters associated with one or more hypothetical PDCCH block error rates (BLERs),
one or more reference signal parameters associated with the one or more hypothetical PDCCH BLERS,
an evaluation time window,
one or more radio network temporary identifiers (RNTIs) associated with one or more hybrid automatic repeat request (HARQ) BLERs, or
one or more radio bearer identifiers or logical channel identifiers associated with one or more radio link control (RLC) BLERs.

5. The apparatus of claim 3, wherein the radio link configuration indicates one or more downlink lower-layer radio link parameter thresholds associated with the one or more downlink lower-layer radio link parameters, and wherein the one or more downlink lower-layer radio link parameter thresholds include one or more of:
a hypothetical physical downlink control channel (PDCCH) block error rate (BLER) threshold,
a counter threshold associated with the PDCCH BLER threshold,
a hybrid automatic repeat request (HARQ) BLER threshold, or
a radio link control (RLC) BLER threshold.

6. The apparatus of claim 1, wherein the one or more sets of lower-layer radio link parameters include one or more uplink lower-layer radio link parameters.

7. The apparatus of claim 6, wherein the one or more uplink lower-layer radio link parameters include one or more of:
a prediction time window,
a maximum permissible exposure (MPE),
a maximum power reduction (MPR),
one or more radio network temporary identifiers (RNTIs) associated with one or more hybrid automatic repeat request (HARQ) block error rates (BLERs),
one or more radio bearer identifiers or logical channel identifiers associated with one or more radio link control (RLC) BLERs, or
one or more radio bearer identifiers or logical channel identifiers associated with uplink transmission delay.

8. The apparatus of claim 6, wherein the radio link configuration indicates one or more uplink lower-layer radio link parameter thresholds associated with the one or more uplink lower-layer radio link parameters, and wherein the one or more uplink lower-layer radio link parameter thresholds include one or more of:
a hybrid automatic repeat request (HARQ) block error rate (BLER) threshold,
a radio link control (RLC) BLER threshold,
a maximum permissible exposure (MPE) threshold,
a maximum power reduction (MPR) threshold,
an uplink transmission delay threshold, or
an RLC retransmission threshold.

9. The apparatus of claim 1, wherein at least one processor of the one or more processors is configured to cause the UE to:
receive one or more uplink resource configurations associated with one or more secondary carriers or neighboring cells;
transmit one or more uplink communications in accordance with the one or more uplink resource configurations and the one or more dynamically selected sets of the one or more sets of lower-layer radio link parameters; and
receive, in accordance with the one or more uplink communications, an indication of a selected secondary carrier or neighboring cell of the one or more secondary carriers or neighboring cells.

10. An apparatus for wireless communication at a network node, comprising:
one or more memories storing processor-executable code; and
one or more processors coupled with the one or more memories, at least one processor of the one or more processors configured to cause the network node to:
transmit a radio link configuration of one or more sets of lower-layer radio link parameters; and
receive, in accordance with the radio link configuration, a channel status report associated with one or more dynamically selected sets of the one or more sets of lower-layer radio link parameters.

11. The apparatus of claim 10, wherein at least one processor of the one or more processors is configured to cause the network node to:
transmit an indication of the one or more dynamically selected sets of the one or more sets of lower-layer radio link parameters.

12. The apparatus of claim 10, wherein the one or more dynamically selected sets comprise one or more autonomously selected sets of the one or more sets of lower-layer radio link parameters.

13. The apparatus of claim 10, wherein the channel status report indicates whether the one or more dynamically selected sets of the one or more sets of lower-layer radio link parameters include one or more downlink lower-layer radio link parameters, one or more uplink lower-layer radio link parameters, or one or more downlink lower-layer radio link parameters and one or more uplink lower-layer radio link parameters.

14. The apparatus of claim 10, wherein the channel status report indicates one or more of:
one or more parameter set identifiers of the one or more dynamically selected sets of the one or more sets of lower-layer radio link parameters,
one or more measurement sources or measurement types associated with the one or more dynamically selected sets of the one or more sets of lower-layer radio link parameters,
one or more measurement results or prediction results associated with the one or more dynamically selected sets of the one or more sets of lower-layer radio link parameters,
one or more predicted times associated with the one or more prediction results, or
one or more confidence levels associated with the one or more measurement results or prediction results.

15. The apparatus of claim 10, wherein at least one processor of the one or more processors is configured to cause the network node to:
transmit one or more uplink resource configurations associated with one or more secondary carriers or neighboring cells;
receive one or more uplink measurement results in accordance with the one or more uplink resource configurations and the one or more dynamically selected sets of the one or more sets of lower-layer radio link parameters; and
transmit, in accordance with the one or more uplink measurement results, an indication of a selected secondary carrier or neighboring cell of the one or more secondary carriers or neighboring cells.

16. The apparatus of claim 15, wherein the one or more uplink resource configurations include one or more physical uplink shared channel (PUSCH) resource configurations, one or more random access channel (RACH) resource configurations, or one or more sounding reference signal (SRS) resource configurations, wherein the one or more uplink resource configurations are carrier-specific or cell-specific, or wherein the one or more secondary carriers are in an inactivated state.

17. The apparatus of claim 10, wherein at least one processor of the one or more processors is configured to cause the network node to:
receive an indication of a user equipment (UE) capability associated with the one or more sets of lower-layer radio link parameters.

18. A method of wireless communication performed at a user equipment (UE), comprising:
receiving a radio link configuration of one or more sets of lower-layer radio link parameters; and
transmitting, in accordance with the radio link configuration, a channel status report associated with one or more dynamically selected sets of the one or more sets of lower-layer radio link parameters.

19. The method of claim 18, further comprising:
generating a prediction result in accordance with the one or more dynamically selected sets of the one or more sets of lower-layer radio link parameters.

20. The method of claim 19, wherein generating the prediction result includes generating the prediction result using an artificial intelligence or machine learning (AI/ML) model.
